(19) United States
(12) Patent Application Publication
(10) Pub. No.: US 2026/0239155 A1
(43) Pub. Date: Aug. 13, 2026

(54) CONDITIONAL RECONFIGURATION METHOD AND APPARATUS, DEVICE, STORAGE MEDIUM, AND PROGRAM PRODUCT

(71) Applicant: Beijing Xiaomi Mobile Software Co., Ltd., Beijing (CN)

(72) Inventors: Yi XIONG, Beijing (CN); Yumin WU, Beijing (CN)

(73) Assignee: Beijing Xiaomi Mobile Software Co., Ltd., Beijing (CN)

(21) Appl. No.: 19/155,292

(22) PCT Filed: Feb. 16, 2023
(86) PCT No.: PCT/CN2023/076603

§ 371 Date: Aug. 11, 2025

(51) Int. Cl. H04W 36/36

(52) U.S. Cl. CPC H04W 36/362

(57) ABSTRACT

A conditional reconfiguration method. The conditional reconfiguration method includes, after successfully accessing a target cell or a target cell group, performing a conditional reconfiguration procedure. The conditional reconfiguration procedure refers to a procedure of processing a mobility action based on conditional triggering performed by a terminal device. The conditional reconfiguration method may be implemented in a system.

### CROSS REFERENCE TO RELATED APPLICATION

The present application is a U.S. National Stage of International Application No. PCT/CN2023/076603, filed on Feb. 16, 2023, the contents of which are incorporated herein by reference in its entirety.

### TECHNICAL FIELD

Embodiments of the present application relate to the communication technical field, and in particular to a conditional reconfiguration method and apparatus, a device, a storage medium, and a program product.

### BACKGROUND

A terminal device may support simultaneous configuration of Conditional Handover (CHO) and Conditional Primary secondary cell Addition or Change (Conditional PSCell Addition or Change, CPAC). However, regarding how the terminal device executes CHO and CPAC, further study is needed.

### SUMMARY

According to an aspect of an embodiment of the present application, there is provided a conditional reconfiguration method. The method is performed by a terminal device, and the method includes:
after successfully accessing a target cell or a target cell group, performing a conditional reconfiguration procedure, wherein the conditional reconfiguration procedure refers to a procedure of processing a mobility action based on conditional triggering performed by the terminal device.

According to an aspect of an embodiment of the present application, a conditional reconfiguration method is provided. The method includes:
sending first configuration information to a terminal device, wherein the first configuration information includes configuration information of a conditional reconfiguration, and the configuration information of the conditional reconfiguration is used for a conditional reconfiguration procedure, and the conditional reconfiguration procedure is performed by the terminal device after the terminal device successfully accesses a target cell or a target cell group, and the conditional reconfiguration procedure refers to a procedure of processing a mobility action based on conditional triggering performed by the terminal device.

According to an aspect of an embodiment of the present application, there is provided a communication device. The communication device includes a processor and a memory, the memory stores a computer program, and the processor executes the computer program to implement the above described conditional reconfiguration method at the terminal device side, or to implement the above described conditional reconfiguration method at the network device side. For example, the communication device is the terminal device or the network device.

According to an aspect of an embodiment of the present application, there is provided a non-transitory computer-readable storage medium. A computer program is stored in the non-transitory storage medium, and when the computer program is executed by a processor, the above described conditional reconfiguration method at the terminal device side is implemented, or the above described conditional reconfiguration method at the network device side is implemented.

According to an aspect of an embodiment of the present application, a chip is provided. The chip includes a programmable logic circuit and/or program instructions, and when the chip is running, the above described conditional reconfiguration method at the terminal device side is implemented, or the above described conditional reconfiguration method at the network device side is implemented.

According to an aspect of an embodiment of the present application, a computer program product is provided. The computer program product includes a computer program, the computer program is stored in a computer-readable storage medium, and a processor reads and executes the computer program from the computer-readable storage medium to implement the above described conditional reconfiguration method at the terminal device side, or to implement the above described conditional reconfiguration method at the network device side.

According to an aspect of an embodiment of the present application, there is provided a communication system. The communication system includes a terminal device and a network device. The terminal device is configured to implement the above described conditional reconfiguration method at the terminal device side, the network device is configured to implement above described conditional reconfiguration method at the network device side.

### BRIEF DESCRIPTION OF THE DRAWINGS

FIG. 1 is a schematic diagram of a network architecture provided by an embodiment of the present application;

FIG. 2 is a schematic diagram of dual connectivity provided by an embodiment of the present application;

FIG. 3 is a schematic diagram of dual connectivity provided by another embodiment of the present application;

FIG. 4 is a schematic diagram of a master cell group and a secondary cell group provided by an embodiment of the present application;

FIG. 5 is a flowchart of a conditional reconfiguration method provided by an embodiment of the present application;

FIG. 6 is a flowchart of a conditional reconfiguration method provided by another embodiment of the present application;

FIG. 7 is a flowchart of a conditional reconfiguration method provided by another embodiment of the present application;

FIG. 8 is a flowchart of a conditional reconfiguration method provided by another embodiment of the present application;

FIG. 9 is a flowchart of a conditional reconfiguration method provided by another embodiment of the present application;

FIG. 10 is a flowchart of a conditional reconfiguration method provided in another embodiment of the present application;

FIG. 11 is a block diagram of a first conditional reconfiguration apparatus provided by an embodiment of the present application;

FIG. 12 is a block diagram of a first conditional reconfiguration apparatus provided by another embodiment of the present application;

FIG. 13 is a block diagram of a second conditional reconfiguration apparatus provided by an embodiment of the present application;

FIG. 14 is a schematic diagram of a structure of a communication device provided by an embodiment of the present application.

### DETAILED DESCRIPTION

To make the objectives, technical solutions, and advantages of the present application clearer, implementations of the present application will be further described in detail below in conjunction with the accompanying drawings.

The network architecture and service scenarios described in embodiments of the present application are intended to more clearly illustrate the technical solutions of the embodiments of the present application, and do not constitute a limitation on the technical solutions provided in the embodiments of the present application. It is known to those skilled in the art that with the evolution of the network architecture and the emergence of new service scenarios, the technical solutions provided in the embodiments of the present application are also applicable to similar technical problems. The number of entities in the drawings provided in the embodiments of the present application is not limited, and may be one or more. The connection relationships shown in the drawings are only examples, and any subjects may be connected or not connected; the connection methods between the subjects may be a direct connection or an indirect connection, or a wired connection or a wireless connection, which is not limited in the present application.

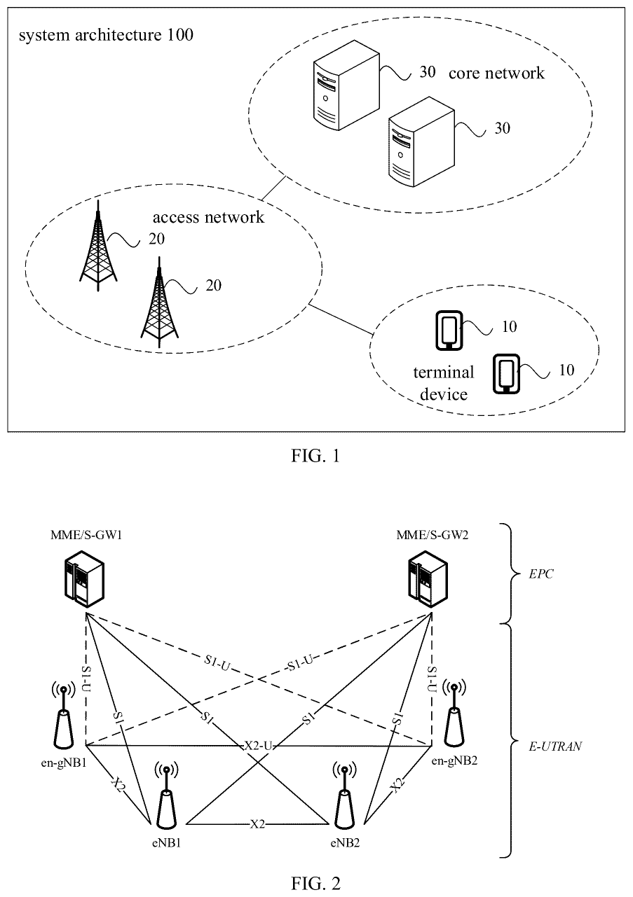

FIG. 1 shows a schematic diagram of a system architecture provided by an embodiment of the present application. The system architecture 100 may include: a terminal device 10, an access network device 20, and a core network device 30.

The terminal device 10 may refer to User Equipment (UE), an access terminal, a user unit, a user station, a mobile station, a mobile, a remote station, a remote terminal, a mobile device, a wireless terminal device, a user agent, or a user device. Optionally, the terminal device 10 may also be a cellular phone, a cordless phone, a Session Initiation Protocol (SIP) phone, a Wireless Local Loop (WLL) station, a Personal Digital Assistant (PDA), a handheld device with a wireless communication function, a computing device or other processing device connected to a wireless modem, a vehicle-mounted device, a wearable device, a terminal device in a 5th Generation System (5GS, fifth generation mobile communication system) or a terminal device in a future evolved Public Land Mobile Network (PLMN), etc., and the embodiments of the present application are not limited to the examples. For the convenience of description, the above-mentioned devices are collectively referred to as a terminal device. The number of terminal devices 10 is usually multiple, and one or more terminal devices 10 may be distributed in a cell managed by each access network device 20. In the embodiments of the present application, “terminal device” and “UE” are often used interchangeably, and those skilled in the art will appreciate that the two usually express the same meaning.

The access network device 20 is a device deployed in an access network to provide wireless communication functions for terminal device(s) 10. The access network device 20 may include various forms, such as a macro base station, a micro base station, a relay station, an access point, etc. In systems using different radio access technologies, the names of devices with access network device functions may be different. For example, in the 5G NR system, the device is called a gNodeB or gNB. With the evolution of communication technologies, the name “access network device” may change. For the convenience of description, in the embodiments of the present application, the above-mentioned devices that provide wireless communication functions for the terminal device(s) 10 are collectively referred to as an access network device. Optionally, a communication relationship may be established between a terminal device 10 and a core network device 30 through an access network device 20. For example, in the LTE system, the access network device 20 may be Evolved Universal Terrestrial Radio Access Network (E-UTRAN) or one or more eNodeBs in the EUTRAN; in the 5G NR system, the access network device 20 may be Radio Access Network (RAN) or one or more gNBs in RAN.

The functions of the core network device 30 are mainly to provide user connection, user management, and service bearing. And, as a bearer network, the core network device provides an interface to an external network. For example, the core network device in the 5G New Radio (5G NR) system may include devices such as an Access and Mobility Management Function (AMF) entity, a User Plane Function (UPF) entity, and a Session Management Function (SMF) entity.

In an example, the access network device 20 and the core network device 30 communicate with each other through an air communication technology, such as a NG interface in the 5G NR system. The access network device 20 and the terminal device 10 communicate with each other through an air communication technology, such as a Uu interface.

The following optional solutions may be combined with the technical solutions of the subsequent embodiments in any combination, all of which fall within the scope of protection of the embodiments of the present application. The embodiments of the present application may include at least part of the following contents.

### I. Dual Connectivity

### 1. MR-DC (Multi-Radio Dual Connectivity)

MR-DC is a generalized Intra Evolved Universal Terrestrial Radio Access (Intra-E-UTRA) dual connectivity, where a UE may utilize radio resources provided by two distinct schedulers located in two different Next Generation Radio Access Network (NG-RAN) nodes connected through a non-ideal backhaul. One scheduler provides NR access, and the other scheduler provides E-UTRA or NR access. One scheduler acts as an MN, and the other scheduler acts as a Secondary Node (SN). The MN and SN are connected through a network interface, and at least one MN is connected to a core network.

### 2. MR-DC With EPC (Evolved Packet Core, 4G Core Network)

The E-UTRAN supports MR-DC through E-UTRA-NR DC (E-UTRA-NR Dual Connectivity, also known as EN-DC), where a UE is connected to an eNB acting as an MN and an en-gNB acting as an SN. The eNB is connected to the EPC through an SI interface and to the en-gNB through an X2 interface. The en-gNB is connected to the EPC through a S1-U interface and to other en-gNBs through an X2-U interface.

For example, the EN-DC architecture is shown in FIG. 2. An en-gNB1 is connected to Mobility Management Entity/Serving GateWay 1 (MME/S-GW1) and MME/S-GW2 through an S1-U interface. An en-gNB2 is connected to MME/S-GW1 and MME/S-GW2 through an S1-U interface. The en-gNB1 is connected to the en-gNB2 through an X2-U interface. The eNB1 is connected to MME/S-GW1 and MME/S-GW2 through an S1 interface. The eNB2 is connected to MME/S-GW1 and MME/S-GW2 through an S1 interface. The eNB1 is connected to eNB2 through an X2 interface. The MME/S-GW1 and MME/S-GW2 belong to EPC, and the en-gNB1, the en-gNB2, the eNB1, and the eNB2 belong to E-UTRAN.

### 3. MR-DC with 5GC (5th Generation Core)

### A: E-UTRA-NR DC (E-UTRA-NR Dual Connectivity, Also Known as NGEN-DC)

The NG-RAN supports NG-RAN E-UTRA-NR Dual Connectivity (also known as NGEN-DC), where a UE is connected to an ng-eNB acting as an MN and a gNB acting as an SN. The ng-eNB is connected to the 5GC, and the gNB is connected to the ng-eNB through an Xn interface.

### B: NR-E-UTRA DC (NR-E-UTRA Dual Connectivity, Also Known as NE-DC)

The NG-RAN supports NR-E-UTRA DC, where a UE is connected to a gNB acting as an MN and an ng-eNB acting as an SN. The gNB is connected to the 5GC, and the ng-eNB is connected to the gNB through the Xn interface.

### C: NR-NR Dual Connectivity (Also Known as NR DC)

The NG-RAN supports NR-NR DC, where a UE is connected to a gNB acting as an MN and another gNB acting as an SN. The gNB (also called a primary gNB) acting as the MN is connected to the 5GC through a NG interface, and the two gNBs are connected through the Xn interface. The gNB (also called a secondary gNB) acting as the SN may also be connected to the 5GC through a NG-U interface. In addition, in NR-DC, the UE may also access a single gNB, which acts as both an MN and an SN, and the gNB is configured with both MCG and SCG.

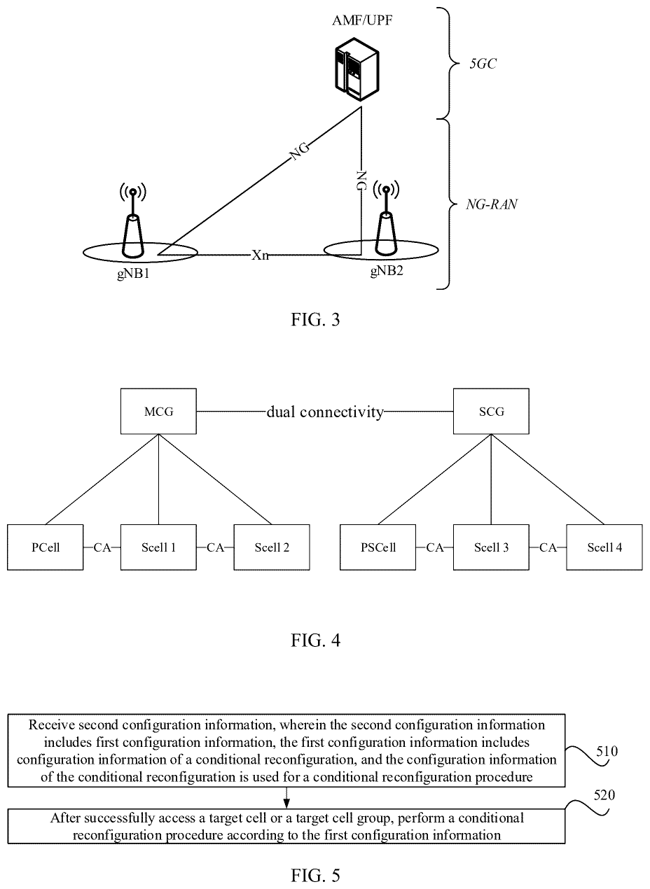

For example, the NR-DC architecture is shown in FIG. 3. A gNB1 acting as an MN is connected to a gNB2 acting as an SN through an Xn interface, the gNB1 is connected to AMF/UPF through an NG-U interface, and the gNB2 is connected to AMF/UPF through an NG-U interface. The AMF/UPF belongs to 5GC, and the gNB1 and the gNB2 belong to NG-RAN.

In dual connectivity, a UE may access two cell groups, namely an MCG and an SCG. In an MCG, there may be many cells, one of which is used to initiate initial access, and this cell is called PCell. As the name suggests, the PCell is the most “primary” cell in the MCG. The primary cell in the MCG is called PCell, and a secondary cell is called SCell (Secondary Cell). The primary cell in the SCG is called Primary Secondary Cell (PSCell), and the secondary cell is called SCell. The PCell in the MCG and the SCell in the MCG are combined through Carrier Aggregation (CA). Because many pieces of signaling are only sent on PCell and PSCell, for the convenience of description, PCell and PSCell may also be collectively referred to as special Cell (sPCell).

For example, as shown in FIG. 4, in dual connectivity, a UE may access two cell groups, namely an MCG and an SCG. The MCG includes a PCell, a SCell 1, and a SCell 2, and the SCG includes a PSCell, a SCell 3, and a SCell 4. In the MCG, the PCell and the SCell 1, and the SCell 1 and the SCell 2 are combined together through CA; in the SCG, the PSCell and the SCell 3, and the SCell 3 and the SCell 4 are combined together through CA.

### II. Selective Activation of Cell Groups

For CHO, CPA/CPC (CPA and CPC may also be collectively referred to as CPAC), a UE with CHO/CPA/CPC configuration(s) needs to release the CHO/CPA/CPC configuration(s) when completing random access to a target PCell/PSCell. If a network device does not reconfigure and initialize CHO/CPA/CPC for the UE, the UE will no longer have the opportunity to continue to execute CHO/CPA/CPC. Therefore, the network device needs to reconfigure and initialize CHO/CPA/CPC for the UE, which will increase the delay of conditional handover or SCG change and increase the signal transmission overhead. Especially in a Frequency Range 2 (FR2) scenario, this problem is more prominent when the Cell group (CG) is frequently changed.

Thus, selective activation of cell groups in MR-DC is proposed, which can ensure that after CG change, the subsequent configuration for selective activation of cell groups can still be executed without the need for the network device to reconfigure or initialize the corresponding configuration for selective activation of cell groups for the UE. This can save signaling processes, reduce signaling transmission overhead, and reduce the interruption duration of CG change.

The configuration for selective activation of cell groups may include at least one of: a configuration ID, a configuration for a cell/cell group to be activated. Optionally, the configuration for selective activation of cell groups may also include an activation condition.

Therefore, in the selective activation of cell groups, the network device may provide a terminal with a “cell group to be activated”. The terminal device may subsequently activate or deactivate the “cell group to be activated” without the need for the network device to re-provide the configuration for the cell group.

That is, in the selective activation of cell groups, after activating a new cell group configuration, the UE will not remove the configuration for the selective activation of the cell groups.

Currently, the selective activation of SCG is being studied to enable a terminal device to continue a subsequent CPC procedure after SCG change or addition without an RRC reconfiguration.

In the selective activation of cell groups, a network device may provide the terminal device with pre-configured candidate target cell group(s) and/or target cell(s). The terminal device may subsequently activate or deactivate a pre-configured candidate target cell and/or target cell group according to a configuration (e.g., an activation message) sent by the network device or a corresponding activation event, without the need of re-providing the configuration for the candidate target cell and/or target cell group. Alternatively, in the selective activation of cell groups, after activating a new cell or cell group, or applying a new cell configuration or cell group configuration, or accessing a new cell or cell group, the UE will not remove corresponding configuration information for the selective activation of cell groups.

The selective activation of cell groups may also be referred to as cell group activation. Cell group activation enables corresponding configuration information to be executed after cell and/or cell group change, without the need for the network device to reconfigure or reinitialize the corresponding configuration information for cell group activation. Therefore, selective activation of cell groups can reduce signaling overhead and the interruption duration of a cell group change. The configuration information for cell group activation may include: a configuration ID and configuration(s) of target cell(s) or configuration(s) of target cell group(s). Optionally, the configuration information for cell group activation may also include a trigger condition (or referred to as an execution condition, an activation condition).

The selective activation of cell groups is a mobility management procedure, including any kind of mobility management procedure in which a UE activates or deactivates a corresponding cell or cell group, or applies a corresponding cell configuration or cell group configuration or accesses the cell or cell group, according to signaling sent by the network device, a principle specified in a specification, or a UE autonomous mode, etc.

The selective activation of cell groups is a mobility management procedure, including any kind of mobility management procedure in which, after the mobility procedure is executed, deletion or release of a corresponding part or all of the configuration information is not performed. Not deleting or releasing the corresponding part or all of the configuration information may also be called retaining the corresponding part or all of the configuration information.

### 3. LTM (L1/L2-Triggered Mobility)

In the 5G system, a network device may provide multiple “candidate cells (or candidate cell groups)” to a terminal device. The network device may subsequently control the terminal device to change among multiple “candidate cells (or candidate cell groups)” (for example, changing the working cell (or cell group) from “candidate cell-1 (or candidate cell group-1)” to “candidate cell-2 (or candidate cell group-2)”) through L1 signaling (such as Downlink Control Information (DCI)) or L2 signaling (such as MAC CE (Control Element)). One serving cell (or cell group) may correspond to one or more “candidate cells (or candidate cell groups)”.

### 4. Conditional Reconfiguration

ConditionalReconfiguration is used to configure, modify, or release configuration information of a conditional reconfiguration.

The ConditionalReconfiguration includes condReconfigToAddModList, condReconfigToRemoveList and attemptCondReconfig.

The condReconfigToRemoveList includes CondReconfigId, and the CondReconfigToAddMod corresponds to configuration information of a conditional reconfiguration.

The CondReconfigToAddModList includes a list of conditional reconfigurations to add or modify, with for each entry the condReconfigId and the associated condExecutionCond/condExecutionCondSCG and condRRCReconfig.

The CondReconfigToAddModList includes one or more CondReconfigToAddMod(s), wherein each CondReconfigToAddMod includes condReconfigId, condExecutionCond, and condRRCReconfig, wherein condRRCReconfig includes CondReconfigExecCondSCG.

### 1. CHO

CHO refers to a handover performed by a UE when one or more handover execution conditions are met. The UE starts evaluating the execution condition(s) after receiving the CHO configuration and stops evaluating the execution condition(s) after performing the handover (including legacy handover, legacy handover and CHO). The following principles apply to CHO:
(1) A CHO configuration includes a configuration of CHO candidate cell(s) and execution condition(s).
(2) An execution condition may include one or two trigger conditions (CHO event A3/A5)
a: CondEvent A3: Conditional reconfiguration candidate becomes amount of offset better than PCell/PSCell.
b: CondEvent A5: PCell/PSCell becomes worse than absolute threshold1 AND Conditional reconfiguration candidate becomes better than another absolute threshold2.
(3) Before any CHO execution condition is met, upon reception of a handover command (without a CHO configuration) by a UE, a legacy HO procedure is executed regardless of any previously received CHO configuration.
(4) While executing CHO, that is, from the time the UE starts to synchronize with a target cell, the UE no longer monitors the original cell.

### 2. CPA

A Conditional PSCell Addition (CPA) is defined as a PSCell addition that is executed by the UE when the execution condition(s) are met. The UE starts evaluating the execution condition(s) upon receiving the CPA configuration, and stops evaluating the execution condition(s) once PSCell addition or PCell change is triggered.

The trigger condition for CPA may be CondEvent A4.

CondEvent A4: Conditional reconfiguration candidate becomes better than absolute threshold.

### 3. CPC

A Conditional PSCell Change (CPC) is defined as a PSCell change that is executed by the UE when the execution condition(s) are met. The UE starts evaluating the execution condition(s) upon receiving the CPC configuration, and stops evaluating the execution condition (s) once PSCell change or PCell change is triggered. Intra-SN CPC without MN involvement, inter-SN CPC initiated either by MN or SN are supported.

The trigger condition for the CPC initiated by the MN may be CondEvent A4.

CondEvent A4: Conditional reconfiguration candidate becomes better than absolute threshold.

The trigger condition for the CPC initiated by the SN may be CondEvent A3/A5.

CondEvent A3: Conditional reconfiguration candidate becomes amount of offset better than PCell/PSCell.

CondEvent A5: PCell/PSCell becomes worse than absolute threshold1 AND Conditional reconfiguration candidate becomes better than another absolute threshold2.

### 4. CHO and CPAC Joint Configuration

Mobility management based on conditional triggering means that the UE implements mobility management based on conditional triggering based on the condition(s) configured by the network and the associated candidate cell(s). After the condition(s) is(are) met, the UE triggers mobility management and accesses its associated candidate cell(s). The condition(s) configured by the network may be specific event(s) based on measurement result(s), or may be location-based or time-based event(s). The associated candidate cell(s) may be a candidate primary cell and a primary secondary cell, corresponding to the corresponding mobility management (CHO and CPC/CPA) based on conditional triggering, respectively. Optionally, MN-initiated CHO, MN-initiated CPA/CPC, and SN-initiated CPC are supported.

However, it is not currently supported to configure CHO and CPA/CPC at the same time. In order to improve robustness and reduce the impact on UE throughput, a solution combining CHO and CPC/CPA is proposed, and it is decided to include a target MCG and a candidate SCG for CPC/CPA in CHO. A UE with a joint configuration of CHO and CPA/CPC can execute CHO and its corresponding CPA/CPC at the same time.

There are three specific configuration methods for the joint configuration of CHO and CPAC:

Configuration method 1: Nested configuration. The configuration of CHO and its one or more associated CPACs is included in the configuration information of a conditional reconfiguration (first ConditionalReconfiguration). The configuration information for one or more CPACs (second conditionalReconfiguration) is included in the configuration information for CHO (CondReconfigToAddMod), and the configuration information for CHO (CondReconfigToAddMod) includes:
a first configuration identity (first condReconfigId), a first execution condition corresponding to CHO (first condExecutionCond), and a first candidate target configuration (first RRCReconfiguration message (first condRRCReconfig)). The first candidate target configuration includes configuration information for one or more CPACs (second conditionalReconfiguration).

Configuration method 2: the configuration information of a conditional reconfiguration includes execution conditions for CHO and CPAC and the configurations of candidate MCG(s) and candidate SCG(s).

Configuration method 3: CHO and CPAC are configured through configuration information of two independent conditional reconfigurations, and then associated through association information.

In the above three configuration methods, the execution conditions for CHO and CPAC may be represented by one or more measurement identities. One measurement identity may be associated with one trigger event.

Currently, the specific configuration scheme to achieve the joint configuration of CHO and CPAC is still under discussion.

For the case of joint configuration of CHO and CPAC, what can be determined is the Execution order: the UE doesn't execute CPC/CPA unless CHO condition is fulfilled (regardless parallel or sequential evaluation).

However, the terminal device supports the configuration of both CHO and CPAC at the same time, but the two are independent. After a UE executes CHO or CPAC, the UE removes the stored configuration information of the conditional reconfiguration corresponding to the MCG configuration (CHO) and SCG configuration (CPAC). For the configuration method 1 in the above-mentioned joint configuration of CHO and CPAC, the configuration for CPAC is included in the configuration information of the conditional reconfiguration corresponding to CHO. If the configuration for CHO includes CPC/CPA, the UE applies the configuration for CPAC only in a case where the execution condition(s) for CHO is(are) met. When the UE accesses the target MCG, the UE simultaneously applies the CPAC configuration and the procedure for accessing the target MCG. When the UE successfully accesses the target MCG, the UE releases all configuration information of the conditional reconfiguration (CHO configuration and CPAC configuration). If CPAC is not triggered after UE successfully accesses the MCG, the CPAC configuration will be removed, which will cause a situation that the UE lacks the CPAC configuration and cannot trigger CPAC normally.

In an embodiment, the mobility action for a cell and/or cell group includes one or more of the following: selective activation of cell(s) and/or cell group(s), a mobility action for cell(s) and/or cell group(s) based on conditional triggering, and a mobility action triggered based on indication information of MAC CE or DCI. For example, the mobility action may include: addition and/or change of a cell or cell group for the UE to access.

An embodiment of the present application proposes a method for executing a mobility action process when the mobility of MCG and the mobility of SCG are jointly configured. The method can ensure that after the UE executes or triggers the mobility of MCG, the corresponding SCG mobility configuration information still exists to realize the execution of subsequent SCG mobility-related action(s).

For example, the mobility of the MCG includes the mobility of a PCell, such as CHO, HO, PCell selective activation, LTM, etc.

For example, the mobility of SCG includes the mobility of a PSCell, such as CPA, CPC, PSCell addition, PSCell change, PSCell selective activation, LTM, etc.

For example, an embodiment of the present application proposes a method for executing CPAC when CHO and CPAC are jointly configured. The method can ensure that after a UE executes or triggers CHO, the corresponding CPAC configuration information still exists to realize subsequent CPAC execution by the UE.

Referring to FIG. 5, a flowchart of a conditional reconfiguration method provided by an embodiment of the present application is shown. The method is performed by a terminal device, and the method may include at least one of the following steps 510 to 520.

In step 510, second configuration information is received. The second configuration information includes the first configuration information. The first configuration information includes configuration information of a conditional reconfiguration. The configuration information of the conditional reconfiguration is used in a conditional reconfiguration procedure.

In step 520, after successfully accessing a target cell or a target cell group, the conditional reconfiguration procedure is performed according to the first configuration information.

In some embodiments, the first configuration information further includes configuration information for a configuration or reconfiguration procedure of a mobility action. For example, the first configuration information may include configuration information for a mobility action based on network signaling triggering. For example, the first configuration information includes configuration information for a mobility action based on a handover command.

In some embodiments, the terminal device receives second configuration information. The second configuration information includes the first configuration information. The second configuration information includes information used to configure the target cell or the target cell group. For example, a network device sends the second configuration information to the terminal device, and the second configuration information includes the first configuration information. Accordingly, the terminal device receives the second configuration information sent by the network device.

The target cell refers to a cell that the terminal device determines to access, or a cell that the terminal device has successfully accessed. The target cell group refers to a cell group that the terminal device determines to access, or a cell group that the terminal device has successfully accessed.

In some embodiments, the target cell may also be a candidate cell (or referred to as a candidate target cell). The terminal device may select a cell from candidate cells as the cell that the terminal device determines to access. The target cell group may also be a candidate cell group (or referred to as a candidate target cell group), and the terminal device may select a cell group from candidate cell groups as the cell group that the terminal device determines to access.

The configuration or reconfiguration procedure of the mobility action refers to a procedure of processing the mobility action performed by the terminal device.

In some embodiments, the mobility action includes at least one of the following: a mobility action based on conditional triggering, or a mobility action based on network signaling triggering.

In some embodiments, the mobility action based on conditional triggering includes at least one of the following: CHO, CPA, CPC, cell or cell group activation based on conditional triggering, or cell or cell group deactivation based on conditional triggering.

In some embodiments, the mobility action based on network signaling triggering includes at least one of the following: cell or cell group activation based on network signaling triggering, cell or cell group deactivation based on network signaling triggering.

The network signaling includes at least one of the following: Layer 1 (L1) signaling, Layer 2 (L2) signaling, or Layer 3 (L3) signaling.

L1 may be a physical layer, and L1 signaling may be DCI signaling. L2 may be a MAC layer, and L2 signaling may be MAC CE signaling. L3 may be an RRC layer, and the L3 signaling may be an RRC message.

In some embodiments, an RRC message is received, and the RRC message includes the second configuration information.

In some embodiments, the second configuration information is configured by an RRC message, or it can be said that the second configuration information is carried by the RRC message, or it can be said that the second configuration information includes the RRC message, or it can also be said that the second configuration information is represented by the RRC message.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solution provided by the embodiments of the present application, by including the first configuration information in the second configuration information, when the terminal device performs the mobility action, the terminal device can obtain information related to the configuration or reconfiguration procedure of the mobility action from the information for the target cell or target cell group, without the need for network device to send the information, thus saving signaling process.

In some embodiments, the first configuration information is configuration information of a conditional reconfiguration, and the first configuration information is used in the conditional reconfiguration procedure. The conditional reconfiguration procedure refers to a procedure of processing a mobility action based on conditional triggering performed by the terminal device. That is, the conditional reconfiguration procedure is a procedure of processing a first mobility action, and the first mobility action is the mobility action based on conditional triggering performed by the terminal device.

The procedure of processing the mobility action based on conditional triggering performed by the terminal device includes at least one of: conditional reconfiguration addition, conditional reconfiguration modification, conditional reconfiguration removal, conditional reconfiguration evaluation, or conditional reconfiguration execution.

The configuration information of the conditional reconfiguration refers to the configuration information used to configure the conditional reconfiguration procedure. For example, the configuration information of the conditional reconfiguration may be conditionalReconfiguration.

In some embodiments, the configuration information of the conditional reconfiguration may be first conditional reconfiguration information or second conditional reconfiguration information. The first conditional reconfiguration information is used to configure mobility action(s) related to an MCG and/or a PCell. The second conditional reconfiguration information is used to configure mobility action(s) related to an SCG and/or a PSCell.

In some embodiments, the first conditional reconfiguration information may include configuration information of one or more first conditional reconfigurations. The terminal device may update or remove the configuration information of the conditional reconfiguration(s) stored in the terminal device according to the configuration information of one or more first conditional reconfigurations included in the first conditional reconfiguration information, which is included in the second configuration information. Configuration information of one first conditional reconfiguration entry is used to configure information for a candidate MCG and/or PCell.

For example, the first conditional reconfiguration information may be a first conditionalReconfiguration, and the configuration information of the first conditional reconfiguration may be a first CondReconfigToAddMod (conditional reconfiguration for addition or removal). The terminal device may update or remove the conditionalReconfiguration stored in the terminal device according to one or more first CondReconfigToAddMod(s) included in the first conditionalReconfiguration which is included in the second configuration information.

In some embodiments, the configuration information of one first conditional reconfiguration entry includes at least one of the following: a first configuration identity, a first execution condition corresponding to the mobility action, or RRC reconfiguration information that needs to be applied when the first execution condition is met.

The first configuration identity is used to uniquely identify the configuration information of the first conditional reconfiguration. The first execution condition corresponding to the mobility action refers to a trigger condition for the mobility action based on conditional triggering. The RRC reconfiguration information that needs to be applied when the first execution condition is met refers to configuration information used to configure the target MCG and/or target PCell for the mobility action based on conditional triggering.

In some embodiments, the target MCG mentioned in the embodiments of the present application may also be a candidate MCG (or referred to as a candidate target MCG), which is not limited in the present application. A candidate MCG refers to an MCG that may be used for a mobility action. For example, a terminal device selects one MCG from multiple candidate MCGs as a target MCG.

In some embodiments, the target PCell mentioned in the embodiments of the present application may also be a candidate PCell (or referred to as a candidate target PCell), which is not limited in the present application. A candidate PCell refers to a PCell that may be used for a mobility action. For example, a terminal device selects a PCell from multiple candidate PCells as a target PCell.

For example, the first configuration identity may be a first condReconfigId (a conditional reconfiguration identity). The first execution condition corresponding to the mobility action based on conditional triggering may be a first condExecutionCond (a conditional execution condition). The RRC reconfiguration information that needs to be applied when the first execution condition is met may be a first RRCReconfiguration (an RRC reconfiguration).

In some embodiments, the first RRCReconfiguration may be carried in a first condRRCReconfig (a conditional RRC reconfiguration), or it may also be said that the first RRCReconfiguration may be configured by the first condRRCReconfig.

In some embodiments, the RRC reconfiguration information that needs to be applied when the first execution condition is met includes configuration information of a conditional reconfiguration for configuring CHO. For example, the RRC reconfiguration information that needs to be applied when the first execution condition is met includes a target MCG for a mobility action based on conditional triggering.

In some embodiments, the RRC reconfiguration information that needs to be applied when the first execution condition is met includes second conditional reconfiguration information, and the second conditional reconfiguration information is used to configure a conditional reconfiguration procedure for CPAC.

In some embodiments, the second conditional reconfiguration information may be second conditionalReconfiguration.

In some embodiments, the second conditional reconfiguration information may include configuration information of one or more second conditional reconfigurations. The terminal device may update or remove the second conditional reconfiguration information stored in the terminal device according to the configuration information of one or more second conditional reconfigurations included in the second conditional reconfiguration information, which is included in the configuration information of the conditional reconfiguration. The configuration information of one second conditional reconfiguration entry is used to configure information for a candidate SCG and/or PSCell.

For example, the configuration information of the conditional reconfiguration may be conditionalReconfiguration, the second conditional reconfiguration information may be second conditionalReconfiguration, and the configuration information of a second conditional reconfiguration may be a second CondReconfigToAddMod (a conditional reconfiguration for addition or deletion). The terminal device may update or remove the second conditionalReconfiguration stored in the terminal device according to one or more second CondReconfigToAddMods included in the second conditionalReconfiguration which is included in the conditionalReconfiguration.

In some embodiments, the configuration information of one second conditional reconfiguration includes at least one of the following: a second configuration identity, a second execution condition corresponding to a mobility action based on conditional triggering, or RRC reconfiguration information that needs to be applied when the second execution condition is met.

The second configuration identity is used to uniquely identify the configuration information of the second conditional reconfiguration. The second execution condition corresponding to the mobility action based on conditional triggering refers to a trigger condition for a CPAC mobility action. The RRC reconfiguration information that needs to be applied when the second execution condition is met refers to configuration information used to configure the target SCG and/or target PSCell for the mobility action based on conditional triggering.

In some embodiments, the target SCG mentioned in the embodiments of the present application may also be a candidate SCG (or referred to as a candidate target SCG), which is not limited in the present application. A candidate SCG refers to an SCG that may be used for a mobility action. For example, a terminal device selects an SCG from multiple candidate SCGs as a target SCG.

In some embodiments, the target PSCell mentioned in the embodiments of the present application may also be a candidate PSCell (or referred to as a candidate target PSCell), which is not limited in the present application. A candidate PSCell refers to a PSCell that may be used for a mobility action. For example, a terminal device selects a PSCell from multiple candidate PSCells as a target PSCell.

For example, the second configuration identity may be a second condReconfigId (a conditional reconfiguration identity), the second execution condition corresponding to the mobility action based on conditional triggering may be a second condExecutionCond (a conditional execution condition), and the RRC reconfiguration information that needs to be applied when the second execution condition is met may be a second RRCReconfiguration (RRC reconfiguration).

In some embodiments, the second RRCReconfiguration may be carried in a second condRRCReconfig (a conditional RRC reconfiguration), or it may be said that the second RRCReconfiguration may be configured by the second condRRCReconfig.

In some embodiments, the RRC reconfiguration information that needs to be applied when the second execution condition is met includes configuration information of a conditional reconfiguration for configuring CPAC. For example, the RRC reconfiguration information that needs to be applied when the second execution condition is met includes a target SCG for a mobility action based on conditional triggering.

In some embodiments, a list for storing configuration information of conditional reconfigurations is maintained in the terminal device, and the terminal device may update or remove the configuration information of the conditional reconfigurations stored in the list for storing configuration information of the conditional reconfigurations according to the configuration information of the conditional reconfiguration included in the second configuration information.

For example, the list for storing configuration information of conditional reconfigurations maintained in the terminal device is VarConditionalReconfig (a conditional reconfiguration list), and the configuration information of a conditional reconfiguration may be CondReconfigToAddMod. The terminal device may update or remove CondReconfigToAddMod(s) stored in VarConditionalReconfig according to conditionalReconfiguration included in the second configuration information.

In some embodiments, the conditional reconfiguration procedure includes at least one of: conditional reconfiguration addition, conditional reconfiguration modification, conditional reconfiguration removal, conditional reconfiguration evaluation, and conditional reconfiguration execution.

The conditional reconfiguration addition refers to adding the first configuration information to the configuration information of conditional reconfiguration(s) stored in the terminal device.

For example, the configuration information of the conditional reconfiguration(s) stored in the terminal device includes configuration information of a conditional reconfiguration corresponding to MCG1 and configuration information of a conditional reconfiguration corresponding to MCG2, the first configuration information includes configuration information of a conditional reconfiguration corresponding to MCG3, and the conditional reconfiguration addition refers to storing the configuration information of the conditional reconfiguration corresponding to MCG3 to the terminal device. Accordingly, the configuration information of the conditional reconfiguration(s) stored in the terminal device is updated to: the configuration information of the conditional reconfiguration corresponding to MCG1, the configuration information of the conditional reconfiguration corresponding to MCG2, and the configuration information of the conditional reconfiguration corresponding to MCG3.

The conditional reconfiguration modification refers to modifying the configuration information of conditional reconfiguration(s) stored in the terminal device according to the first configuration information. In some embodiments, the first configuration information is used to configure a CPAC procedure.

For example, the configuration information of the conditional reconfiguration(s) stored in the terminal device includes configuration information of a conditional reconfiguration corresponding to MCG1 and configuration information of a conditional reconfiguration corresponding to MCG2, the first configuration information includes configuration information of the conditional reconfiguration corresponding to MCG2, and the conditional reconfiguration modification refers to modifying the configuration information of the conditional reconfiguration corresponding to MCG2 stored in the terminal device according to the configuration information of the conditional reconfiguration corresponding to MCG2 included in the first configuration information.

Conditional reconfiguration removal refers to removing the first configuration information in the configuration information of conditional reconfiguration(s) stored in the terminal device.

For example, the configuration information of the conditional reconfiguration(s) stored in the terminal device includes configuration information of a conditional reconfiguration corresponding to MCG1 and configuration information of a conditional reconfiguration corresponding to MCG2. The first configuration information indicates that the configuration information of the conditional reconfiguration corresponding to MCG2 needs to be removed. The conditional reconfiguration removal refers to removing the configuration information of the conditional reconfiguration corresponding to MCG2 from the terminal device, and the configuration information of the conditional reconfiguration(s) stored in the terminal device is updated to the configuration information of the conditional reconfiguration corresponding to MCG1.

The conditional reconfiguration evaluation refers to evaluating an execution condition for the mobility action based on conditional triggering corresponding to the configuration information of conditional reconfiguration(s) stored in the terminal device.

In some embodiments, the configuration information of a conditional reconfiguration includes an execution condition corresponding to a mobility action based on conditional triggering, and the conditional reconfiguration evaluation refers to evaluating the execution condition corresponding to the mobility action based on conditional triggering included in the configuration information of conditional reconfiguration(s) stored in the terminal device.

The conditional reconfiguration execution refers to executing a mobility action based on conditional triggering corresponding to the configuration information of conditional reconfiguration(s) stored in the terminal device.

In some embodiments, when the first configuration information is configuration information of a conditional reconfiguration, step 510 in the above embodiment may be changed to obtaining the configuration information of the conditional reconfiguration (first configuration information) included in the second configuration information, and the configuration information of the conditional reconfiguration is used in a conditional reconfiguration procedure, and the conditional reconfiguration procedure refers to a procedure of processing the mobility action based on conditional triggering performed by the terminal device.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solutions provided by the embodiments of the present application, by including the configuration information of a conditional reconfiguration in the second configuration information, when the terminal device performs a mobility action, the terminal device can obtain information related to the configuration or reconfiguration procedure for the mobility action based on conditional triggering from the information for the target cell or target cell group, without the need for network device to send the information, thus saving signaling process.

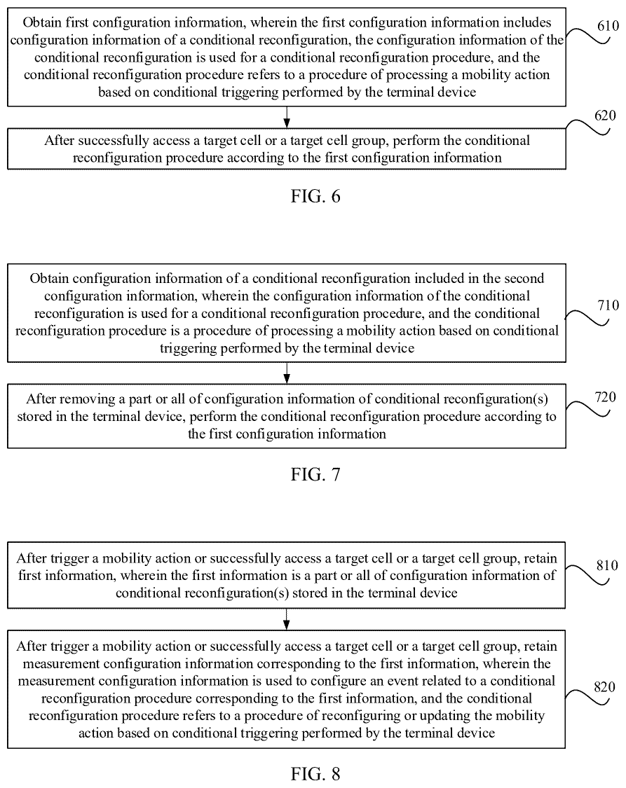

Referring to FIG. 6, a flowchart of a conditional reconfiguration method provided by an embodiment of the present application is shown. The method is performed by a terminal device, and the method may include at least one of the following steps 610 to 620.

In step 610, the first configuration information is obtained. The first configuration information includes configuration information of a conditional reconfiguration. The configuration information of the conditional reconfiguration is used in a conditional reconfiguration procedure. The conditional reconfiguration procedure refers to a procedure of processing a mobility action based on conditional triggering performed by the terminal device.

In some embodiments, a network device sends the first configuration information to the terminal device, and correspondingly, the terminal device receives the first configuration information sent by the network device.

Step 610 is the same as step 510 introduced in the above embodiments. For details of the solution not described in step 610, reference may be made to the above embodiments, and repeated description will be omitted here.

In step 620, after successfully accessing a target cell or target cell group, the conditional reconfiguration procedure is performed according to the first configuration information.

In some embodiments, after successfully accessing the target cell or target cell group, the terminal device performs the conditional reconfiguration procedure according to the configuration information of the conditional reconfiguration.

In some embodiments, the procedure of the terminal device accessing the target cell or target cell group is a mobility action, which may be a mobility action based on conditional triggering or a mobility action based on network signaling triggering, and the present application does not limit this.

In some embodiments, the first configuration information includes: configuration information used to configure or reconfigure a CPAC procedure; the target cell is a PCell corresponding to a CHO procedure, and the target cell group is an MCG corresponding to the CHO procedure.

In some embodiments, if the procedure of the terminal device accessing the target cell or the target cell group is a mobility action based on conditional triggering, the procedure of the terminal device accessing the target cell or the target cell group may be a CHO procedure. In this case, the second configuration information may be the RRC reconfiguration information that needs to be applied when the first execution condition is met included in the above-described first conditional reconfiguration information. The configuration information of the conditional reconfiguration is the second conditional reconfiguration information included in the RRC reconfiguration information that needs to be applied when the first execution condition is met. The second conditional reconfiguration information includes configuration information used to configure or reconfigure the CPAC procedure.

For example, the procedure of the terminal device accessing the target cell or the target cell group is a CHO procedure, the second configuration information is first RRCReconfiguration, and the configuration information of the conditional reconfiguration is second conditionalReconfiguration included in the first RRCReconfiguration.

In this case, the target cell is a PCell corresponding to the CHO procedure, and the target cell group is an MCG corresponding to the CHO procedure. For example, the target cell or target cell group is a PCell or an MCG included in the configuration information for a target MCG for configuring the mobility action based on conditional triggering included in the first RRCReconfiguration.

In some embodiments, the first configuration information includes: configuration information used to configure or reconfigure the CHO procedure and/or the CPAC procedure; the target cell is a cell included in a handover command, the target cell group is a cell group included in the handover command, and the handover command is used to indicate the terminal device to switch to the target cell and/or target cell group.

In some embodiments, if the procedure of the terminal device accessing the target cell or target cell group is a mobility action procedure based on network signaling triggering, the procedure of the terminal device accessing the target cell or target cell group may be a mobility action based on a handover command. In this case, the second configuration information may be the handover command, or information used to configure the target cell or target cell group included in the handover command. The configuration information of the conditional reconfiguration may be the first conditional reconfiguration information described above. The first conditional reconfiguration information includes the configuration information used to configure or reconfigure the CHO procedure and/or the CPAC procedure.

For example, the procedure of the terminal device accessing the target cell or the target cell group is a mobility action procedure based on a handover command, the second configuration information is the handover command, and the configuration information of the conditional reconfiguration is the first conditionalReconfiguration included in the handover command.

In this case, the target cell is a cell included in the handover command, and the target cell group is a cell group included in the handover command.

n some embodiments, the second configuration information includes synchronization reconfiguration information, and the conditional reconfiguration procedure is performed according to the first configuration information.

In some embodiments, in a case where the second configuration information includes the synchronization reconfiguration information, the conditional reconfiguration procedure is performed according to the first configuration information. The synchronization reconfiguration information is used to configure a synchronization procedure between the terminal device and the target cell or target cell group.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solutions provided by the embodiments of the present application, the second configuration information includes the configuration information of the conditional reconfiguration. When the terminal device performs a mobility action, the terminal device can obtain information related to the configuration or reconfiguration procedure for the mobility action based on conditional triggering from the information for the target cell or target cell group, without the need for network device to send the information, thus saving signaling process.

Moreover, after the terminal device successfully accesses the target cell or target cell group, or removes the configuration information of a conditional reconfiguration stored in the terminal device, the terminal device performs the conditional reconfiguration procedure according to the configuration information of the conditional reconfiguration in this case, and can obtain the configuration information of the conditional reconfiguration, so as to facilitate the execution of subsequent mobility action based on conditional triggering.

Referring to FIG. 7, a flowchart of a conditional reconfiguration method provided by an embodiment of the present application is shown. The method is performed by a terminal device, and the method may include at least one of the following steps 710 to 720.

In step 710, configuration information of a conditional reconfiguration included in second configuration information is obtained. The configuration information of the conditional reconfiguration is used in a conditional reconfiguration procedure. The conditional reconfiguration procedure refers to a procedure of processing a mobility action based on conditional triggering performed by the terminal device.

Step 710 is the same as step 510 described in the above embodiments. For details of the solution not described in step 710, reference may be made to the above embodiments and repeated descriptions will be omitted here.

In step 720, after removing part or all of configuration information of conditional reconfiguration(s) stored in the terminal device, the conditional reconfiguration procedure is performed according to the first configuration information.

In some embodiments, the conditional reconfiguration procedure is performed after deleting part or all of the configuration information of the conditional reconfiguration(s) stored in the terminal device.

In some embodiments, if the terminal device removes part or all of the configuration information of the conditional reconfiguration(s) stored in the terminal device, the terminal device performs the conditional reconfiguration procedure according to the first configuration information.

In the technical solutions provided in the embodiments of the present application, after deleting part or all of the configuration information of the conditional reconfiguration(s) stored in the terminal device, the terminal device performs the conditional reconfiguration procedure according to the first configuration information. Thus, the technical solutions can avoid the problem that the terminal device removes the configuration information of the conditional reconfiguration(s) stored in the terminal device due to other reasons, which results in that the terminal device cannot perform a subsequent mobility action based on conditional triggering normally.

Regarding steps 510, 610 to 620, and 710 to 720 described in the above embodiments, the present application provides an example embodiment for further explanation. This embodiment is described by taking an example where the procedure of the terminal device successfully accessing the target cell or target cell group is a mobility action procedure based on conditional triggering, and the terminal device performs a conditional reconfiguration procedure according to the first configuration information.

A UE receives a first conditionalReconfiguration sent by a network device. The first conditionalReconfiguration includes one or more first CondReconfigToAddMod(s). The UE may update or remove configuration information of conditional reconfiguration(s) stored in the terminal device according to the first conditionalReconfiguration. That is, the UE receives the first conditionalReconfiguration sent by the network device, and updates the list VarConditionalReconfig for storing the configuration information of the conditional reconfiguration(s) based on the first conditionalReconfiguration. For example, the terminal device adds configuration information of a conditional reconfiguration newly configured in the first conditionalReconfiguration, and updates or removes configuration information of the conditional reconfiguration(s) stored in the terminal device (updates or removes the configuration information of conditional reconfiguration(s) which is included in the configuration information of the conditional reconfiguration(s) stored in the terminal device but not included in the first conditionalReconfiguration). A first CondReconfigToAddMod is used to configure the mobility of an MCG and the mobility of an SCG. The first CondReconfigToAddMod includes one or more of the following information: a first configuration identity (first condReconfigId), a first execution condition (condExecutionCond) corresponding to the MCG mobility, or a first RRCReconfiguration message (first condRRCReconfig) that needs to be applied when the first execution condition is met.

In some embodiments, the first RRCReconfiguration includes one or more pieces of second conditional reconfiguration information, and the second conditional reconfiguration information is used to configure the mobility of an SCG.

The first RRCReconfiguration message includes second conditionalReconfiguration, and the second conditionalReconfiguration includes one or more second CondReconfigToAddMod(s). In addition, the first RRCReconfiguration message further includes a configuration for a target MCG corresponding to the first CondReconfigToAddMod.

The second CondReconfigToAddMod includes one or more of the following information: a second configuration identity, a second execution condition corresponding to SCG mobility (condExecutionCond or condExecutionCondSCG), or a second RRCReconfiguration message (second condRRCReconfig) that needs to be applied when the first execution condition is met. The second RRCReconfiguration message includes a configuration for a target SCG corresponding to the second CondReconfigToAddMod.

In some embodiments, the first execution condition and the second execution condition may indicate one or more measurement identities. An execution condition is met only when all events corresponding to the measurement identity(identities) indicated by the execution condition are met.

For the first conditionalReconfiguration stored in the UE, the UE evaluates whether the corresponding first execution condition is met. In a case where the first execution condition is met, the UE applies the first condRRCReconfig, that is, starts a response process upon receipt of the first RRCReconfiguration message.

In some embodiments, if the first RRCReconfiguration message includes configuration information for a target MCG corresponding to a first CondReconfigToAddMod to which the message belongs, the UE performs a cell group configuration process based on the configuration information for the target MCG.

In some embodiments, the first RRCReconfiguration message includes a second conditionalReconfiguration, then:
1. If the first RRCReconfiguration message is included in the first condRRCReconfig (or the first RRCReconfiguration message is represented by the first condRRCReconfig, or the first RRCReconfiguration message is included in the first conditionalReconfiguration, or the first RRCReconfiguration corresponds to a first configuration identity (condReconfigId)), the UE continues to perform following process:

If the UE successfully accesses a cell group corresponding to the first RRCReconfiguration (i.e., when the MAC layer of the corresponding cell group successfully completes the random access procedure) and/or if the VarConditionalReconfig corresponding to the MCG and/or SCG is empty, the UE performs the conditional reconfiguration procedure (based on the second conditionalReconfiguration).
2. If the condition in above-described 1 is not met, the UE performs the conditional reconfiguration procedure (based on the second conditionalReconfiguration).

In some embodiments, the first RRCReconfiguration message includes a second conditionalReconfiguration, then:
1. If the first RRCReconfiguration message includes synchronization reconfiguration (reconfiguration WithSync) information, for example, a PSCell included in the MCG included in the first RRCReconfiguration message includes reconfiguration WithSync, the UE continues with the following process:

If the UE successfully accesses the cell group corresponding to the first RRCReconfiguration (i.e., the MAC layer of the corresponding cell group successfully completes the random access procedure) and/or if the VarConditionalReconfig corresponding to the MCG and/or SCG is empty, the UE performs the conditional reconfiguration procedure (based on the second conditionalReconfiguration). 2. If the condition in the above described 1 is not met, the UE performs the conditional reconfiguration procedure (based on the second conditionalReconfiguration).

In some embodiments, a conditional reconfiguration method is provided. The method is performed by a terminal device and may be implemented as at least one of the following steps.

In step 1, when a UE successfully accesses a target cell group/cell, the UE performs a conditional reconfiguration procedure.

The conditional reconfiguration procedure includes one or more of the following: conditional reconfiguration addition, modification, removal, evaluation, or execution.

In step 2, if the UE successfully accesses the target cell group or target cell, and/or the UE removes all or part of the configuration information of conditional reconfiguration(s) stored in the UE, the UE performs the conditional reconfiguration procedure.

In step 3, if the configuration information of the conditional reconfiguration is included in the second configuration information and the second configuration information is used to configure information for the target cell or target cell group, when the UE successfully accesses the target cell group or target cell corresponding to the second configuration information, the UE performs the conditional reconfiguration procedure. The second configuration information includes or is represented by an RRCReconfiguration message.

In step 4, If the conditional reconfiguration is included in the second configuration information (the second configuration information is used to configure the information for target cell or target cell group), and the second configuration information includes synchronization reconfiguration information, when the UE successfully accesses the target cell group or target cell corresponding to the second configuration information, the UE performs the conditional reconfiguration procedure. The second configuration information includes or is represented by an RRCReconfiguration message.

It should be noted that for a scenario of joint configuration of CHO and CPAC: the conditional reconfiguration procedure mentioned in step 1 is the conditional reconfiguration procedure for configuring CPAC configuration information, the target cell group is an MCG corresponding to the CHO procedure, and the target cell is a PCell corresponding to the CHO procedure; the second configuration information is candidate second configuration information, and the candidate second configuration information is candidate second configuration information corresponding to the CHO procedure; the second configuration information includes synchronization reconfiguration information, and also includes configuration information used to configure the CPAC procedure.

For a scenario where a handover command includes a configuration of conditional reconfiguration: the conditional reconfiguration procedure mentioned in step 1 is a conditional reconfiguration procedure for configuring CPAC or CHO configuration information, the target cell group is a target cell group included in the handover command, and the target cell is a target cell included in the handover command. The second configuration information is second configuration information included in the handover command. The second configuration information includes synchronization reconfiguration information and configuration information used to configure the CHO procedure or the CPAC procedure.

Referring to FIG. 8, a flowchart of a conditional reconfiguration method provided by an embodiment of the present application is shown. The method is performed by a terminal device, and the method may include step 810.

In step 810, after a mobility action is triggered or a target cell or target cell group is successfully accessed, the first information is retained. The first information is part of all of configuration information of conditional reconfiguration(s) stored in the terminal device.

Triggering a mobility action refers to a situation where a terminal device determines a target cell or target cell group to access, but has not yet successfully accessed the target cell or target cell group.

In some embodiments, the first information includes at least one of the following: configuration information of a conditional reconfiguration associated with the target cell or the target cell group; configuration information of a conditional reconfiguration included in mobility configuration information that triggers the mobility action; first configuration information including configuration information of a conditional reconfiguration, where the configuration information of the conditional reconfiguration is used for a conditional reconfiguration procedure; configuration information of a conditional reconfiguration indicated by a network device.

In some embodiments, the configuration information of the conditional reconfiguration associated with the target cell or target cell group refers to configuration information of a conditional reconfiguration, including information used to configure the target cell or target cell group. For example, the configuration information of the conditional reconfiguration associated with the target cell or target cell group is conditionalReconfiguration 1,and conditionalReconfiguration 1 includes RRCReconfiguration 1. RRCReconfiguration 1includes configuration information used to configure the target cell or target cell group.

In some embodiments, the configuration information of the conditional reconfiguration included in the mobility configuration information that triggers the mobility action may be a handover command. For example, the handover command includes the configuration information of the conditional reconfiguration.

In some embodiments, the configuration information of the conditional reconfiguration indicated by the network device refers to configuration information of a conditional reconfiguration indicated by the network device to the terminal device through indication information. For example, the terminal device receives the indication information sent by the network device, and the indication information includes configuration information of a conditional reconfiguration that needs to be retained.

In some embodiments, the second configuration information includes synchronization reconfiguration information. The second configuration information is used to configure information for the target cell or target cell group. The synchronization reconfiguration information is used to configure a synchronization procedure between the terminal device and the target cell or target cell group. The configuration information of the conditional reconfiguration included in the mobility configuration information that triggers the mobility action is the configuration information of the conditional reconfiguration associated with the target cell or target cell group.

For example, the second configuration information includes synchronization reconfiguration information. The second configuration information is used to configure information for the target cell or target cell group. The target cell or target cell group configured by the second configuration information, and the target cell or target cell group corresponding to the mobility configuration information that triggers the mobility action, are the same target cell or target cell group. Therefore, the configuration information of the conditional reconfiguration included in the mobility configuration information that triggers the mobility action is the configuration information of the conditional reconfiguration associated with the target cell or target cell group, that is, both are the same configuration information of the conditional reconfiguration.

In some embodiments, as shown in FIG. 8, the method may further include step 820. After triggering the mobility action or successfully accessing the target cell or target cell group, measurement configuration information corresponding to the first information is retained. The measurement configuration information is used to configure event(s) related to the conditional reconfiguration procedure corresponding to the first information, and the conditional reconfiguration procedure refers to a procedure of reconfiguring or updating the mobility action based on conditional triggering performed by the terminal device.

The measurement configuration information is used to configure event(s) related to the conditional reconfiguration procedure corresponding to the first information. The conditional reconfiguration procedure corresponding to the first information corresponding to the measurement configuration information can only be performed when all events included in the measurement configuration information are met.

After triggering the mobility action or successfully accessing the target cell or target cell group, when the first information is retained, if the measurement configuration information corresponding to the first information is not retained, the subsequent conditional reconfiguration procedure based on conditional triggering cannot be performed.

In some embodiments, the measurement configuration information includes at least one of the following: a measurement identity, a measurement object configuration associated with the measurement identity, or a report configuration.

In some embodiments, step 820 may be performed before step 810, or after step 810, or simultaneously with step 810, which is not limited in the present application.

In some embodiments, the conditional reconfiguration procedure includes at least one of: conditional reconfiguration addition, conditional reconfiguration modification, conditional reconfiguration removal, conditional reconfiguration evaluation, and conditional reconfiguration execution.

The conditional reconfiguration addition refers to adding the first configuration information in configuration information of conditional reconfiguration(s) stored in the terminal device. The conditional reconfiguration modification refers to modifying the configuration information of conditional reconfiguration(s) stored in the terminal device according to the first configuration information. Conditional reconfiguration removal refers to removing the first configuration information in the configuration information of conditional reconfiguration(s) stored in the terminal device. The conditional reconfiguration evaluation refers to evaluating execution condition(s) for a mobility action based on conditional triggering corresponding to the configuration information of the conditional reconfiguration(s) stored in the terminal device. The conditional reconfiguration execution refers to executing the mobility action based on conditional triggering corresponding to the configuration information of the conditional reconfiguration(s) stored in the terminal device.

In some embodiments, the first information includes configuration information used to configure or reconfigure the CPAC procedure; the target cell is a PCell corresponding to the CHO procedure, and the target cell group is an MCG corresponding to the CHO procedure.

In some embodiments, the first configuration information includes configuration information used to configure or reconfigure the CPAC procedure; the target cell is a PCell corresponding to the CHO procedure, and the target cell group is an MCG corresponding to the CHO procedure.

In some embodiments, if the procedure of the terminal device accessing the target cell or the target cell group is a mobility action based on conditional trigger, the procedure of the terminal device accessing the target cell or the target cell group may be a CHO procedure, and in this case, the second configuration information may be the RRC reconfiguration information that needs to be applied when the first execution condition is met included in the first conditional reconfiguration information in the above embodiments, and the first information is the second conditional reconfiguration information included in the RRC reconfiguration information that needs to be applied when the first execution condition is met. The second conditional reconfiguration information includes configuration information used to configure or reconfigure the CPAC procedure.

For example, a procedure of the terminal device accessing the target cell or the target cell group is a CHO procedure, the second configuration information is the first RRCReconfiguration, and the first information is the second conditionalReconfiguration included in the first RRCReconfiguration.

In this case, the target cell is a PCell corresponding to the CHO procedure, and the target cell group is an MCG corresponding to the CHO procedure. For example, the target cell or target cell group is the PCell or MCG included in the configuration information for the target MCG for configuring the mobility action based on conditional triggering included in the first RRCReconfiguration.

In some embodiments, the first information includes: configuration information used to configure or reconfigure the CHO procedure and/or the CPAC procedure; the target cell is a cell included in a handover command, the target cell group is a cell group included in the handover command, and the handover command is used to indicate the terminal device to switch to the target cell and/or target cell group.

In some embodiments, if the procedure of the terminal device accessing the target cell or target cell group is a mobility action procedure based on network signaling triggering, the procedure of the terminal device accessing the target cell or target cell group may be a mobility action based on a handover command. In this case, the second configuration information may be the handover command, or information used to configure the target cell or target cell group included in the handover command, and the first information may be the first conditional reconfiguration information in the above embodiments. The first conditional reconfiguration information includes configuration information used to configure or reconfigure a CHO procedure and/or a CPAC procedure.

For example, the procedure of the terminal device accessing the target cell or the target cell group is a mobility action procedure based on a handover command, the second configuration information is the handover command, and the first information is the first conditionalReconfiguration included in the handover command.

In this case, the target cell is a cell included in the handover command, and the target cell group is a cell group included in the handover command.

In some embodiments, the mobility action includes a mobility action based on conditional triggering and a mobility action based on network signaling triggering.

In some embodiments, the mobility action includes at least one of the following: CHO, CPC, CPA, MCG selective activation, or SCG selective activation.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solutions provided by the embodiments of the present application, after the terminal device triggers a mobility action or successfully accesses a target cell or a target cell group, all or part of the configuration information of the conditional reconfiguration(s) stored in the terminal device is retained, so that the terminal device can perform a subsequent conditional reconfiguration procedure normally, without the need for the network device to resend the configuration information of the conditional reconfiguration, thereby saving signaling processes.

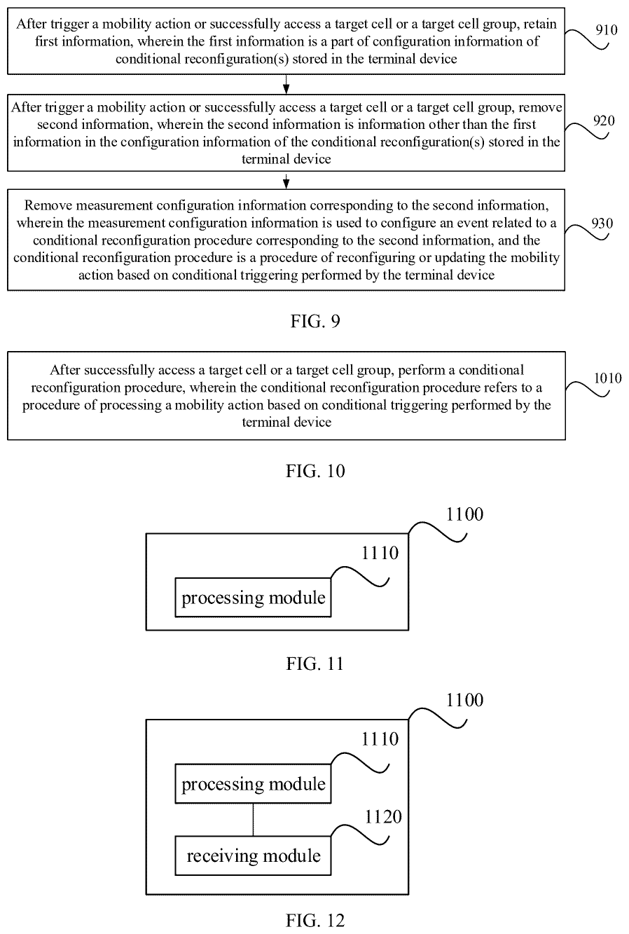

Referring to FIG. 9, a flowchart of a conditional reconfiguration method provided by an embodiment of the present application is shown. The method is performed by a terminal device, and the method may include at least one of the following steps 910 to 920.

In step 910, after a mobility action is triggered or a target cell or target cell group is successfully accessed, the first information is retained. The first information is part of configuration information of conditional reconfiguration(s) stored in the terminal device.

Step 910 is the same as step 810 introduced in the above embodiments. For details of the solution not described in step 910, reference may be made to the above embodiments, and repeated descriptions will be omitted here.

In step 920, after the mobility action is triggered or the target cell or target cell group is successfully accessed, the second information is removed. The second information is information other than the first information in the configuration information of the conditional reconfiguration(s) stored in the terminal device.

In a case where the first information is part of the configuration information of the conditional reconfiguration(s) stored in the terminal device, the terminal device removes the second information.

In some embodiments, the second information includes at least one of the following: configuration information of conditional reconfiguration(s) that is not associated with the target cell or target cell group; mobility configuration information other than configuration information of conditional reconfiguration(s) included in mobility configuration that triggers the mobility action; mobility configuration information other than first configuration information included in second configuration information, wherein the second configuration information is used to configure information for the target cell or target cell group, the first configuration information includes configuration information of a conditional reconfiguration, and the configuration information of the conditional reconfiguration is used in a conditional reconfiguration procedure; configuration information of conditional reconfiguration(s) indicated by a network device.

The configuration information of conditional reconfiguration(s) not associated with the target cell or target cell group refers to configuration information of conditional reconfiguration(s) that does not include the information used to configure the target cell or target cell group. For example, the configuration information of a conditional reconfiguration associated with the target cell or target cell group is conditionalReconfiguration 1, conditionalReconfiguration 1 includes RRCReconfiguration 1, and RRCReconfiguration 1 includes configuration information used to configure the target cell or target cell group. The configuration information of conditional reconfiguration(s) not associated with the target cell or target cell group is conditionalReconfiguration other than conditionalReconfiguration 1 in the configuration information of conditional reconfiguration(s) stored in the terminal device.

In some embodiments, the configuration information of the conditional reconfiguration included in the mobility configuration information that triggers the mobility action may be a handover command. For example, the handover command includes the configuration information of the conditional reconfiguration. The mobility configuration information, other than the configuration information of the conditional reconfiguration included in the mobility configuration that triggers the mobility action, is other information in the handover command than the configuration information of the conditional reconfiguration.

In some embodiments, the configuration information of the conditional reconfiguration(s) indicated by the network device refers to configuration information of conditional reconfiguration(s) indicated by the network device to the terminal device through indication information. For example, the terminal device receives the indication information sent by the network device, and the indication information includes configuration information of conditional reconfiguration(s) that needs to be removed.

For the above steps 910 and 920, only one of the steps may be performed, or all of them may be performed, and the present disclosure does not limit this.

In some embodiments, as shown in FIG. 9, the method further includes step 930: deleting measurement configuration information corresponding to the second information. The measurement configuration information is used to configure event(s) related to a conditional reconfiguration procedure corresponding to the second information. The conditional reconfiguration procedure refers to a procedure of reconfiguring or updating the mobility action based on conditional triggering performed by the terminal.

The measurement configuration information is used to configure event(s) related to the conditional reconfiguration procedure corresponding to the second information. The conditional reconfiguration procedure corresponding to the second information corresponding to the measurement configuration information can only be executed in a case where all events included in the measurement configuration information are met.

After triggering the mobility action or successfully accessing the target cell or target cell group, if the second information is removed, even if the measurement configuration information is retained, the conditional reconfiguration procedure corresponding to the second information corresponding to the measurement configuration information cannot be executed in a case where all event(s) included in the measurement configuration information is(are) met.

In some embodiments, step 930 may be performed before step 910, or after step 920, or simultaneously with step 910 (or step 920), which is not limited in the present application.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solutions provided by the embodiments of the present application, by deleting a part of the configuration information of the conditional reconfiguration(s) stored in the terminal device, and retaining the configuration information of the conditional reconfiguration required for the subsequent conditional reconfiguration procedure, it can be ensured that the terminal device can perform the subsequent conditional reconfiguration procedure normally, and does not require the network device to resend the configuration information of the conditional reconfiguration, thereby saving signaling processes.

In some embodiments, the configuration information of the conditional reconfiguration indicated by the network device mentioned in the above embodiments is sent by the network device to the terminal device through indication information.

In some embodiments, the network device indicates the configuration information of the conditional reconfiguration through indication information. The indication information includes at least one of the following: a configuration identity (ID) corresponding to the configuration information of the conditional reconfiguration; a node corresponding to the configuration information of the conditional reconfiguration; a cell or cell group associated with the configuration information of the conditional reconfiguration; a validity length of time for the configuration information of the conditional reconfiguration; an MCG to which the CPAC configuration information is applicable; a PCell to which the CPAC configuration information is applicable; or an MN to which the CPAC configuration information is applicable.

In some embodiments, the network device indicates the configuration information of the conditional reconfiguration through explicit indication information or implicit indication information.

In an example, the network device indicates the configuration information of the conditional reconfiguration through explicit indication information. For example, the network device sends indication information to the terminal device, and the indication information includes a configuration identity (ID) corresponding to the configuration information of the conditional reconfiguration.

Since the configuration information of the conditional reconfiguration includes a configuration identity used to uniquely identify the configuration information of the conditional reconfiguration, the configuration information of the conditional reconfiguration can be explicitly indicated by the configuration identity (ID) corresponding to the configuration information of the conditional reconfiguration.

In another example, the network device indicates the configuration information of the conditional reconfiguration through implicit indication information. For example, the network device sends indication information to the terminal device, and the indication information includes at least one of the following: a node corresponding to the configuration information of the conditional reconfiguration; a cell or cell group associated with the configuration information of the conditional reconfiguration; a validity length of time for the configuration information of the conditional reconfiguration; an MCG to which the CPAC configuration information is applicable; a PCell to which the CPAC configuration information is applicable; or an MN to which the CPAC configuration information is applicable.

Since the configuration information of each conditional reconfiguration entry has a unique correspondence with the above indication information, the configuration information of the conditional reconfiguration can be implicitly indicated by the above information.

In some embodiments, the configuration information of the conditional reconfiguration(s) indicated in the indication information may include only the configuration information of conditional reconfiguration(s) that the terminal device needs to retain, or may include only the configuration information of conditional reconfiguration(s) that the terminal device needs to remove, or may include both the configuration information of conditional reconfiguration(s) that the terminal device needs to retain and the configuration information of conditional reconfiguration(s) that the terminal device needs to remove, which is not limited in the present disclosure.

For example, the terminal device only performs step 910 above, and the configuration information of the conditional reconfiguration(s) indicated in the indication information only includes the configuration information of conditional reconfiguration(s) (first information) that the terminal device needs to retain, and the terminal device retains the configuration information of conditional reconfiguration(s) indicated in the indication information.

For example, the terminal device only performs step 910 above, and the configuration information of the conditional reconfiguration(s) indicated in the indication information only includes the configuration information of the conditional reconfiguration(s) that the terminal device needs to remove. The terminal device retains configuration information of conditional reconfiguration(s) in the configuration information of conditional reconfiguration(s) stored in the terminal device, other than the configuration information of the conditional reconfiguration(s) indicated in the indication information.

For example, the terminal device only performs the above step 920, and the configuration information of the conditional reconfiguration(s) indicated in the indication information only includes the configuration information of the conditional reconfiguration(s) (second information) that the terminal device needs to remove. The terminal device removes the configuration information of the conditional reconfiguration(s) indicated in the indication information.

For example, the terminal device only performs the above step 920, and the configuration information of the conditional reconfiguration(s) indicated in the indication information only includes the configuration information of the conditional reconfiguration(s) that the terminal device needs to retain. The terminal device removes configuration information of conditional reconfiguration(s) in the configuration information of the conditional reconfiguration(s) stored in the terminal device, other than the configuration information of the conditional reconfiguration(s) indicated in the indication information.

In some embodiments, configuration information of one conditional reconfiguration entry corresponds to one piece of indication information. For configuration information of any conditional reconfiguration entry, the terminal device determines whether to retain or remove the configuration information of the conditional reconfiguration based on whether the network device sends indication information corresponding to the configuration information of the conditional reconfiguration. Alternatively, for configuration information of any conditional reconfiguration entry, the terminal device determines whether to retain or remove the configuration information of the conditional reconfiguration based on a value of the indication information corresponding to the configuration information of the conditional reconfiguration.

For example, the network device configures one piece of corresponding indication information for the configuration information of each conditional reconfiguration entry stored in the terminal device. For example, the configuration information of conditional reconfigurations stored in the terminal device includes information 1, information 2, and information 3, and the corresponding indication information is indication 1, indication 2, and indication 3, respectively.

In some embodiments, for configuration information of any conditional reconfiguration entry, the terminal device determines whether to retain or remove the configuration information of the conditional reconfiguration according to whether the network device sends indication information corresponding to the configuration information of the conditional reconfiguration.

For example, if the network device does not send indication information corresponding to configuration information of a conditional reconfiguration, the terminal device determines to remove the configuration information of the conditional reconfiguration. For example, if the network device only sends indication 1 and indication 2, but does not send indication 3, the terminal device determines to retain information 1 and information 2, and remove information 3.

For example, if the network device does not send indication information corresponding to configuration information of a conditional reconfiguration, the terminal device determines to retain the configuration information of the conditional reconfiguration. For example, if the network device only sends indication 1 and indication 2, but does not send indication 3, the terminal device determines to remove information 1 and information 2, and retain information 3.

In some embodiments, for configuration information of any conditional reconfiguration entry, the terminal device determines whether to retain or remove the configuration information of the conditional reconfiguration according to a value of indication information corresponding to the configuration information of the conditional reconfiguration.

For example, if the value of the indication information is 0, the terminal device determines to remove the configuration information of the conditional reconfiguration corresponding to the indication information. For example, if the values of indication 1, indication 2, and indication 3 are 1, 1, and 0, and the values of indication 3 are 1, 1, and 0, respectively, the terminal device determines to retain information 1 and information 2 and remove information 3.

For example, if the value of the indication information is 1, the terminal device determines to remove the configuration information of the conditional reconfiguration corresponding to the indication information. For example, if the values of indication 1, indication 2, and indication 3 are 1, 1, and 0, respectively, the terminal device determines to remove information 1 and information 2 and retain information 3.

Whether the indication information is used to indicate configuration information of a conditional reconfiguration that the terminal device needs to retain or is used to indicate configuration information of a conditional reconfiguration that the terminal device needs to remove, can be configured by a network, or can be predefined, and the present disclosure does not limit this.

For example, the indication information carries a field which is used to indicate whether the configuration information of a conditional reconfiguration indicated by the indication information is configuration information of the conditional reconfiguration that the terminal device needs to retain or the configuration information of the conditional reconfiguration that the terminal device needs to remove.

For another example, the network device sends second indication information to the terminal device. The second indication information is used to indicate whether the configuration information of a conditional reconfiguration indicated by the indication information is the configuration information of the conditional reconfiguration that the terminal device needs to retain or the configuration information of the conditional reconfiguration that the terminal device needs to remove.

In some embodiments, the indication information may also be used to indicate the type of configuration information of a conditional reconfiguration that the terminal device needs to retain or remove. For example, the indication information is used to indicate the first information that the terminal device needs to retain. The first information includes at least one of the following: configuration information of a conditional reconfiguration associated with a target cell or a target cell group; configuration information of a conditional reconfiguration included in mobility configuration information that triggers a mobility action; first configuration information, wherein the first configuration information includes configuration information of a conditional reconfiguration, and the configuration information of the conditional reconfiguration is used in a conditional reconfiguration procedure.

For example, the indication information is used to indicate the second information that the terminal device needs to remove. The second information includes at least one of the following: configuration information of a conditional reconfiguration that is not associated with the target cell or target cell group; mobility configuration information other than the configuration information of the conditional reconfiguration included in the mobility configuration that triggers the mobility action; mobility configuration information other than first configuration information included in second configuration information, the second configuration information is used to configure information for the target cell or target cell group, the first configuration information includes the configuration information of the conditional reconfiguration, and the configuration information of the conditional reconfiguration is used in the conditional reconfiguration procedure.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In the technical solutions provided in the embodiments of the present application, the network device indicates to the terminal device the configuration information of the conditional reconfiguration(s) that the terminal device needs to retain or remove, network control on the terminal device regarding retention (i.e., not deleting) by the terminal device can be realized, thereby ensuring that the terminal device can normally perform the subsequent conditional reconfiguration procedure.

Regarding steps 810 to 820 and 910 to 930 introduced in the above embodiments, the present application provides an example embodiment for further explanation. This embodiment is described by taking an example in which the procedure of a terminal device successfully accessing a target cell or a target cell group is a mobility action procedure based on conditional triggering.

After a UE successfully accesses an MCG, the UE needs to remove a part of the entries in MCG VarConditionalReconfig (a list storing configuration information of conditional reconfiguration(s) for an MCG) and all entries in SCG VarConditionalReconfig (a list storing configuration information of conditional reconfiguration(s) for an SCG), and retain a part of the entries in the MCG VarConditionalReconfig (CPAC configuration information associated with the target cell or target cell group). After successfully accessing the SCG, the UE removes the retained part of the entries in the MCG VarConditionalReconfig.

In some embodiments, if the first RRCReconfiguration message includes second conditionalReconfiguration, the UE performs a conditional reconfiguration procedure (based on the second conditionalReconfiguration).

In some embodiments, if reconfiguration WithSync (synchronization reconfiguration information) is included in spCellConfig (sPCell reconfiguration) for the MCG (or SCG) included in the first RRCReconfiguration, and the MAC layer of the cell group successfully completes the triggered random access procedure (for example, the spCellConfig for the MCG includes reconfiguration WithSync; or the spCellConfig for the SCG includes reconfiguration WithSync, and CPA or CPC is configured; and the MAC layer of the cell group successfully completes the triggered random access procedure), any one of the following steps is performed:
Step 1: Remove other entries in MCG and SCG VarConditionalReconfig than the entry corresponding to the second condReconfigId in the second conditionalReconfiguration included in the first RRCReconfiguration.
Step 2: Remove all entries in SCG VarConditionalReconfig, and remove other entries in MCG VarConditionalReconfig than the entry corresponding to the second condReconfigId in the second conditionalReconfiguration included in the first RRCReconfiguration.
Step 3: Retain the entry corresponding to the second condReconfigId in the second conditionalReconfiguration included in the first RRCReconfiguration, and remove other entries in the MCG VarConditionalReconfig and SCG VarConditionalReconfig.
Step 4: Retain the entry corresponding to the second condReconfigId in the second conditionalReconfiguration included in the first RRCReconfiguration in MCG VarConditionalReconfig, remove other entries in MCG VarConditionalReconfig, and remove all entries in SCG VarConditionalReconfig.
Step 5: Remove entry(entries) that needs(need) to be removed as indicated by the network from MCG VarConditionalReconfig and SCG VarConditionalReconfig.
Step 6: Remove entries in MCG VarConditionalReconfig and SCG VarConditionalReconfig other than the entry(entries) that needs(need) to be retained as indicated by the network.

In some embodiments, after the UE removes a part of entries in MCG VarConditionalReconfig and SCG VarConditionalReconfig, the UE performs at least one of the following steps:
Step 1: For each measId (measurement ID) corresponding to MCG, and/or for each measId corresponding to SCG, if there is a reportType (report type) set to condTriggerConfig (conditional trigger configuration) in the associated reportConfig (report configuration) and the measId is not indicated in the condExecutionCond or condExecutionCondSCG associated with the condReconfigId in VarConditionalReconfig, the report configuration associated with the measurement identity, the measurement object associated with the measurement identity, and the measurement identity stored in the UE are removed.
Step 2: For each measId corresponding to MCG, and/or for each measId corresponding to SCG, if there is a reportType set to condTriggerConfig in the associated reportConfig, then: if the measId is indicated in the condExecutionCond or condExecutionCondSCG associated with the condReconfigId in VarConditionalReconfig, then the report configuration associated with the measurement identity stored in the UE, the measurement object associated with the measurement identity and the measurement identity are retained; otherwise, the report configuration associated with the measurement identity stored in the UE, the measurement object associated with the measurement identity and the measurement identity are removed.

In some embodiments, the above-mentioned deletion of the report configuration associated with the measurement identity stored in the UE, the measurement object associated with the measurement identity, and the measurement identity may be implemented by the following steps:

For the measurement identity:
for the associated reportConfigId:
remove the entry with the matching reportConfigId from the reportConfigList within the VarMeasConfig (remove the entry with the matching reportConfigId from the reportConfigList (a report reconfiguration list) within the VarMeasConfig (a measurement reconfiguration list);
if the associated measObjectId is only associated to a reportConfig with reportType set to condTriggerConfig (if the measObjectId (a measurement object ID) associated with the measurement identity is only associated to a reportConfig with reportType set to condTriggerConfig);
remove the entry with the matching measObjectId from the measObjectList within the VarMeasConfig;
remove the entry with the matching measId from the measIdList within the VarMeasConfig.

In some embodiments, a conditional reconfiguration method is provided. The method is performed by a terminal device and may include at least one of the following steps.

In step 1, when a UE triggers a mobility action and/or the UE successfully accesses a target cell group or a target cell, the UE retains (or does not remove) configuration information of specific conditional reconfiguration(s), wherein the configuration information of the specific conditional reconfiguration(s) includes at least one of the following:
configuration information of a conditional reconfiguration associated with a target cell or target cell group to be accessed;
configuration information of a conditional reconfiguration included in the second configuration information that needs to be applied for triggering the mobility action (or accessing the target cell/cell group);
configuration information of a conditional reconfiguration included in the second configuration information that needs to be applied for the successfully accessed target cell or target cell group; or
configuration information of a conditional reconfiguration indicated by a network device.

In step 2, when the UE triggers the mobility action and/or the UE successfully accesses the target cell group or target cell, the UE removes specific configuration information of a conditional reconfiguration, where the specific configuration information of the conditional reconfiguration includes at least one of the following:
a configuration of a conditional reconfiguration that is not associated with the target cell or target cell group to be accessed;
mobility configuration information other than configuration information of a conditional reconfiguration included in the second configuration information that needs to be applied for triggering the mobility action;
mobility configuration information other than configuration information of a conditional reconfiguration included in the second configuration information that needs to be applied for the successfully accessed target cell or target cell group; or
configuration information of a conditional reconfiguration indicated by a network device.

In step 3, in a case where the second configuration information includes synchronization reconfiguration information, the configuration information of the conditional reconfiguration included in the second configuration information that needs to be applied for triggering the mobility action (or for the successfully accessed target cell or target cell group) may be a configuration of a conditional reconfiguration associated with the target cell or target cell group to be accessed.

In step 4, the network device may indicate to the terminal device through explicit or implicit indication information the configuration information of a conditional reconfiguration that needs to be removed or retained.

The indication information may be used to indicate at least one of the following:
indicating a measurement identity (ID) corresponding to the configuration information of the conditional reconfiguration that needs to be retained or removed;
indicating a node corresponding to the configuration information of the conditional reconfiguration that needs to be retained or removed;
indicating a cell or cell group associated with the configuration information of the conditional reconfiguration that needs to be retained or removed;
indicating a validity length of time for the configuration information of the conditional reconfiguration that needs to be retained or removed;
indicating an MCG or a PCell or an MN to which CPAC configuration information that needs to be retained or removed is applicable.

In some embodiments, configuration information of each conditional reconfiguration corresponds to one piece of indication information, and the terminal device may determine whether to retain or remove corresponding configuration information of a conditional reconfiguration according to whether the indication information is configured or according to the value corresponding to the indication information.

In step 5, for the configuration information of a conditional reconfiguration that the UE needs to retain, the UE retains a measurement configuration corresponding to the configuration information of the conditional reconfiguration.

In step 6, for the configuration information of a conditional reconfiguration that the UE needs to remove, the UE removes a measurement configuration corresponding to the configuration information of the conditional reconfiguration.

In step 7, the measurement configuration corresponding to the configuration information of the conditional reconfiguration includes at least one of the following: a measurement identity (ID) corresponding to a measurement identity indicated by an execution condition included in the configuration information of the conditional reconfiguration, a measurement object configuration associated with the measurement identity (ID), or a report configuration.

It should be noted that for the scenario of joint configuration of CHO and CPAC: the configuration information of the conditional reconfiguration mentioned in step 1 is configuration information for the CPAC procedure, the target cell group is an MCG corresponding to the CHO procedure, and the target cell is a PCell corresponding to the CHO procedure; the second configuration information is the candidate second configuration information, and the candidate second configuration information is the candidate second configuration information corresponding to the CHO procedure; the second configuration information includes synchronization reconfiguration information, and further includes configuration information used to configure the CPAC procedure. When the UE successfully accesses the MCG or PCell of the CHO procedure, the UE retains the configuration information for the CPAC procedure in the second configuration information and removes the configuration information of other conditional reconfiguration(s).

For the scenario where a handover command includes configuration information of a conditional reconfiguration: the configuration information of conditional reconfiguration mentioned in step 1 is configuration information for the CPAC procedure or the CHO procedure, the target cell group is a target cell group included in the handover command, the target cell is a target cell included in the handover command, and the second configuration information is second configuration information included in the handover command; the second configuration information includes synchronization reconfiguration information, and further includes configuration information used to configure the CHO procedure or the CPAC procedure. When the UE successfully accesses the target PCell or target MCG corresponding to the handover command, the UE retains the configuration information for the CPAC procedure in the second configuration information and removes the configuration information for other conditional reconfiguration(s).

Referring to FIG. 10, a flowchart of a conditional reconfiguration method provided by an embodiment of the present application is shown. The method is performed by a terminal device, and the method may include the following step 1010.

In step 1010, after a target cell or target cell group is successfully accessed, a conditional reconfiguration procedure is performed. The conditional reconfiguration procedure refers to a procedure of processing a mobility action based on conditional triggering performed by the terminal device.

In some embodiments, step 1010 may include at least one of the following steps 1011 to 1012.

In step 1011, after the target cell or target cell group is successfully accessed, the conditional reconfiguration procedure is performed according to the first configuration information.

In step 1012, after deleting part or all of the configuration information of the conditional reconfiguration(s) stored in the terminal device, the conditional reconfiguration procedure is performed according to the second configuration information.

Step 1011 and step 1012 are the same as step 510 introduced in the above embodiments. For details of the solution not described in step 1011 and step 1012, reference may be made to the above embodiments, and repeated descriptions will be omitted here.

In some embodiments, the conditional reconfiguration method may further include at least one of the following steps 1013 to 1014.

In step 1013, after a mobility action is triggered or the target cell or target cell group is successfully accessed, the first information is retained. The first information is part or all of the configuration information of the conditional reconfiguration(s) stored in the terminal device.

In step 1014, after the mobility action is triggered or the target cell or target cell group is successfully accessed, the second information is removed. The second information is information other than the first information in the configuration information of the conditional reconfiguration(s) stored in the terminal device.

It should be noted that step 1013 and step 1014 may be performed before step 1010, may be performed simultaneously with step 1010, or may be performed after step 1010, and the present disclosure does not limit this. Step 1013 is the same as step 810 introduced in the above embodiments. For details of the solution not described in step 1013, reference may be made to the above embodiments, and repeated descriptions will be omitted here.

Step 1014 is the same as step 920 introduced in the above embodiments. For details of the solution not described in step 1014, reference may be made to the above embodiments, and repeated descriptions will be omitted here.

In the technical solutions provided in the embodiments of the present application, a terminal device performs the conditional reconfiguration procedure after the terminal device successfully accesses the target cell or target cell group. There is no need for the network device to reconfigure or reinitialize a configuration of the conditional reconfiguration for the terminal device, thereby saving signaling processes, reducing signaling transmission overhead, and reducing the duration of service interruption caused by a cell group change.

Based on the above embodiments, the present application provides two possible implementations of the conditional reconfiguration method.

In an example, after the UE successfully accesses the target cell/cell group, the UE starts the conditional reconfiguration procedure. Configuration information of a conditional reconfiguration is included in a configuration for the target cell/target cell group. The conditional reconfiguration method may include at least one of the following steps.

In step 1, when the UE successfully accesses the target cell group/target cell, the UE performs the conditional reconfiguration procedure. The conditional reconfiguration procedure includes one or more of the following: conditional reconfiguration addition, modification, removal, evaluation, or execution.

In step 2, based on that the UE successfully accesses the target cell group/target cell in step 1, the UE performing the conditional reconfiguration procedure includes: if the UE successfully accesses the target cell group/cell and/or the UE removes all or part of configuration information of stored conditional reconfiguration(s), the UE performs conditional reconfiguration.

In step 3, based on the UE successfully accessing the target cell group/target cell in step 1, the UE performing the conditional reconfiguration procedure includes: if the configuration information of the conditional reconfiguration is included in a target configuration (second configuration information), and the target configuration is used to configure the target cell or target cell group, when the UE successfully accesses the target cell group/target cell corresponding to the target configuration, the UE performs the conditional reconfiguration procedure. The target configuration includes or is represented by an RRCReconfiguration message.

In step 4, based on the UE successfully accessing a candidate target cell group/target cell in step 3, the UE performing the conditional reconfiguration procedure includes: if the configuration information of the conditional reconfiguration (the configuration information of the conditional reconfiguration for CPAC) is included in the target configuration (the target configuration is used to configure the target cell or target cell group), and the target configuration includes synchronization reconfiguration (synchronization reconfiguration information), when the UE successfully accesses the cell group/target cell corresponding to a candidate target configuration, the UE performs the conditional reconfiguration procedure. The candidate target configuration includes or is represented by an RRCReconfiguration message.

For the scenario of joint configuration of CHO and CPAC: the configuration information of the conditional reconfiguration described in step 1 is the configuration information of the conditional reconfiguration for configuring CPAC configuration information, and the target cell group/target cell described in step 1 is a candidate MCG/PCell corresponding to the CHO configuration; the target configuration is a candidate target configuration, and the candidate target configuration is a candidate target configuration corresponding to the CHO configuration, and the target configuration includes synchronization reconfiguration, and further includes configuration information used to configure CPAC (that is, the configuration information of the conditional reconfiguration described in steps 1 to 4).

For the scenario where a handover command includes a configuration of a conditional reconfiguration: the conditional reconfiguration described in step 1 is the configuration information of the conditional reconfiguration for configuring CPAC or CHO configuration information, the target cell group/target cell is a target cell for the handover, the target configuration is a target configuration in the handover command, and the target configuration includes synchronization reconfiguration, and further includes configuration information used to configure CHO or CPAC (that is, the configuration information of the conditional reconfiguration described in steps 1 to 4).

For the above-mentioned conditional reconfiguration method, the present disclosure takes the CHO and CPAC joint configuration scenario as an example for illustrative explanation.

In step 1, a UE receives first conditionalReconfiguration sent by a network side. The first conditionalReconfiguration includes configuration information of one or more first conditional reconfigurations (CondReconfigToAddModList), which is used to update/remove configuration information of existing first conditional reconfiguration(s). The UE receives the first conditionalReconfiguration sent by the network side and updates the list VarConditionalReconfig storing the configuration information of the conditional reconfiguration(s) based on this message, adds the newly configured configuration information of the first conditional reconfiguration(s), and updates/removes configuration information of existing conditional reconfiguration(s). The configuration information of the first conditional reconfiguration(s) is used to configure MCG mobility and SCG mobility (CHO+CPAC). The configuration information of a first conditional reconfiguration includes one or more of the following information:
1.1. a first configuration identity (first condReconfigId);
1.2. a first execution condition (condExecutionCond) corresponding to MCG mobility (CHO);
1.3. a first RRCReconfiguration message (first condRRCReconfig) that needs to be applied when the first execution condition is met.

In step 2, based on step 1, the configuration information of the first conditional reconfiguration(s) includes configuration information of one or more second conditional reconfiguration(s). The configuration information of the second conditional reconfiguration(s) is used to configure the SCG mobility (CPAC).
2.1. The first RRCReconfiguration message includes second conditionalReconfiguration, the second conditionalReconfiguration includes configuration information of one or more second conditional reconfigurations, and the first RRCReconfiguration message further includes a configuration of candidate MCG(s).
2.2. The configuration information of a second conditional reconfiguration includes a second configuration identity, a second execution condition (condExecutionCond or condExecutionCondSCG) corresponding to the SCG mobility (CPA/CPC), and a second RRCReconfiguration message (second condRRCReconfig) that needs to be applied when the first execution condition is met. The second RRCReconfiguration message further includes a configuration of candidate SCG(s).

In step 3, the first execution condition and the second execution condition may indicate one or more measurement identities. An execution condition is met only when all events corresponding to the measurement identity(identities) indicated by the execution condition are met.

In step 4, for configuration information of a first conditional reconfigurationstored in the UE, the UE evaluates whether corresponding first execution condition(s) is(are) met. When the first execution condition(s) is(are) met, the UE applies the first condRRCReconfig, that is, starts the response process after receiving the first RRCReconfiguration message.

In step 5, based on step 4, if the first RRCReconfiguration message includes an MCG configuration, the UE performs a cell group configuration process based on it.

In step 6, based on step 4, if the first RRCReconfiguration message includes the second conditionalReconfiguration,
6.1. If the first RRCReconfiguration message is included in the first condRRCReconfig (or the first RRCReconfiguration message is represented by the first condRRCReconfig, or the first RRCReconfiguration message is included in the first conditionalReconfiguration, or the first RRCReconfiguration corresponds to a first configuration identity (condReconfigId)), the UE continues with the following process:
6.1.1. If the UE successfully accesses a cell group corresponding to the first RRCReconfiguration (i.e., the MAC layer of the corresponding cell group successfully completes the random access procedure), and/or if the MCG and/or SCG VarConditionalReconfig is empty, the UE performs the following process:
6.1.1.1. The UE performs the conditional reconfiguration procedure (based on the second conditionalReconfiguration).
6.2. Otherwise (6.1 is not met), the UE performs the following process:
6.2.1.1. The UE performs the conditional reconfiguration procedure (based on the second conditionalReconfiguration).

In step 7, based on step 4, if the first RRCReconfiguration message includes the second conditionalReconfiguration, the UE performs the following process:
7.1. If the first RRCReconfiguration message includes synchronization reconfiguration (reconfiguration WithSync), for example, the spCellConfig included in the masterCellGroup included in the first RRCReconfiguration message includes reconfiguration WithSync, the UE continues with the following process:
7.1.1. If the UE successfully accesses the cell group corresponding to the first RRCReconfiguration (i.e., the MAC layer of the corresponding cell group successfully completes the random access procedure), and/or if the MCG and/or SCG VarConditionalReconfig is empty, the UE performs the following process:
7.1.1.1. The UE performs the conditional reconfiguration procedure (based on the second conditionalReconfiguration).
7.2. Otherwise (7.1 is not met), the UE performs the following process:
7.2.1.1. The UE performs the conditional reconfiguration procedure (based on the second conditionalReconfiguration).

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

In another example, after the UE triggers a mobility action or accesses a target cell/cell group, the UE retains (i.e., does not remove) specific configuration information of a conditional reconfiguration. The conditional reconfiguration method may include at least one of the following steps.

In step 1, after the UE triggers mobility and/or the UE successfully accesses a candidate (target) cell group/cell, the UE retains (does not remove) specific configuration information of a conditional reconfiguration. The specific configuration information of the conditional reconfiguration includes:
1.1. configuration information of conditional reconfiguration(s) associated with the target cell/cell group to be accessed;
1.2. configuration information of conditional reconfiguration(s) included in a target configuration that needs to be applied for triggering the mobility action (or for accessing the target cell/cell group);
1.3. configuration information of conditional reconfiguration(s) indicated by the network.

In step 2, when the UE triggers mobility and/or the UE successfully accesses the candidate (target) cell group/cell, the UE removes specific configuration information of conditional reconfiguration(s). The specific configuration information of conditional reconfiguration(s) includes:
2.1. configuration information of conditional reconfiguration(s) that is not associated with the target cell/cell group to be accessed;
2.2. mobility configuration information other than the configuration information of conditional reconfiguration(s) included in the target configuration that needs to be applied for triggering the mobility action (or for the accessed target cell/cell group);
2.3. configuration information of conditional reconfiguration(s) indicated by the network.

In step 3, the configuration information of conditional reconfiguration(s) included in the target configuration that needs to be applied for triggering the mobility action (or for the accessed target cell/cell group) described in step 1 (1.2) may also be the configuration information of conditional reconfiguration(s) associated with the target cell/cell group to be accessed; the target configuration includes synchronization reconfiguration.

In step 4, based on the configuration information of the conditional reconfiguration(s) indicated by the network in step 1, the configuration information of the conditional reconfiguration(s) to be removed or retained may be indicated through explicit or implicit indication information. The indication information may be used to indicate one or more of the following information:
4.1. indicating a configuration ID corresponding to configuration information of conditional reconfiguration(s) that needs to be retained or removed;
4.2. indicating a node corresponding to the configuration information of conditional reconfiguration(s) that needs to be retained or removed;
4.3. indicating a cell/cell group associated with the configuration information of conditional reconfiguration(s) that needs to be retained or removed;
4.4. indicating a validity length of time for the configuration information of conditional reconfiguration(s) that needs to be retained or removed;
4.5. indicating an MCG/PCell/MN to which the CPAC configuration information that needs to be retained or removed is applicable;
4.6. Configuration information of each conditional reconfiguration corresponds to one piece of indication information, and retention or deletion of the corresponding configuration information of the conditional reconfiguration is determined according to whether the indication information is configured or according to a corresponding value.

In step 5, based on step 1, for the configuration information of a conditional reconfiguration that the UE needs to retain, the UE retains a measurement configuration corresponding to the configuration information of the conditional reconfiguration.

In step 6, based on step 2, for the configuration information of a conditional reconfiguration that the UE needs to remove, the UE removes a measurement configuration corresponding to the configuration information of the conditional reconfiguration.

In step 7, the measurement configuration corresponding to the configuration information of the conditional reconfiguration in steps 5 to 6 is one or more or all of: a measurement identity configuration corresponding to a measurement identity indicated by an execution condition included in the configuration information of the conditional reconfiguration, a measurement object configuration associated with the measurement identity, and a report configuration.

For the scenario of joint configuration of CHO and CPAC: the configuration information of the conditional reconfiguration in step 1 is the CPAC configuration information, and the target cell group/target cell in step 1 is a candidate MCG/PCell corresponding to CHO; the target configuration that needs to be applied is a candidate target configuration, and the candidate target configuration is a candidate target configuration corresponding to the CHO configuration, and the target configuration includes synchronization reconfiguration, and further includes a configuration for configuring CPAC. Based on 1.2, when the UE successfully accesses the candidate MCG/PCell for CHO, the UE retains the CPAC configuration in the candidate target configuration and removes configuration information of other conditional reconfiguration(s).

For the scenario where the handover command includes a configuration of a conditional reconfiguration: the configuration information of the conditional reconfiguration in step 1 is CPAC or CHO configuration, the target cell group/target cell is a target cell for handover, the target configuration is a target configuration in the handover command, and the target configuration includes synchronization reconfiguration, and further includes a configuration for configuring CHO or CPAC. Based on 1.2, when the UE successfully accesses the target PCell corresponding to the handover command, the UE retains the CPAC configuration in the target configuration and removes configuration information of other conditional reconfiguration(s).

For the above-mentioned conditional reconfiguration methods, the present disclosure takes the CHO and CPAC joint configuration scenario as an example for illustrative explanation.

After successfully accessing an MCG, a UE needs to remove a part of entries in MCG VarConditionalReconfig and all entries in SCG VarConditionalReconfig, and retain a part of entries in the MCG VarConditionalReconfig (the CPAC configuration associated with the target MCG). After successfully accessing an SCG, the UE removes the configuration information for the CPAC.

Steps 1 to 5 are the same as steps 1 to 5 in the above embodiments, and repeated descriptions will be omitted here.

In step 6, based on step 4, if the first RRCReconfiguration message includes the second conditionalReconfiguration, the UE performs the conditional reconfiguration procedure (based on the second conditionalReconfiguration)

In step 7, if reconfiguration WithSync is included in the spCellConfig for the MCG or SCG in the first RRCReconfiguration, and the MAC layer of the cell group successfully completes the triggered random access procedure, any of the following steps is performed:

(For example, if the spCellConfig for the MCG includes reconfiguration WithSync, or if the spCellConfig for the SCG includes reconfiguration WithSync, and CPA or CPC is configured: and the MAC layer of the cell group successfully completes the triggered random access procedure)
7.1. other entries in MCG and SCG VarConditionalReconfig than the entry corresponding to the second condReconfigId in the second conditionalReconfiguration included in the first RRCReconfiguration are removed;
7.2. all entries in SCG VarConditionalReconfig are removed, and other entries in MCG VarConditionalReconfig than the entry corresponding to the second condReconfigId in the second conditionalReconfiguration included in the first RRCReconfiguration are removed;
7.3. the entry corresponding to the second condReconfigId in the second conditionalReconfiguration included in the first RRCReconfiguration is retained, and other entries in MCG and SCG VarConditionalReconfig are removed;
7.4. all entries in SCG VarConditionalReconfig are removed, the entry corresponding to the second condReconfigId in the second conditionalReconfiguration included in the first RRCReconfiguration in MCG VarConditionalReconfig is retained, and other entries in MCG VarConditionalReconfig are removed;
7.5. entry(entries) to be removed indicated by the network in MCG and SCG VarConditionalReconfig is(are) removed;
7.6. entry(entries) in MCG and SCG VarConditionalReconfig other than entry(entries) to be retained indicated by the network is(are) removed.

In step 8, based on step 7, after the UE removes a part of entries in MCG and SCG VarConditionalReconfig, the UE performs one or more of the following steps:
8.1. for each measId (measurement ID) corresponding to the MCG and for each measId corresponding to the SCG, if the associated reportConfig has a reportType set to condTriggerConfig and the measId is not indicated in the condExecutionCond (associated with the condReconfigId in the VarConditionalReconfig) or condExecutionCondSCG, the report configuration associated with the measurement identity, the measurement object associated with the measurement identity, and the measurement identity stored in the UE are removed;
8.2. for each measId corresponding to the MCG, and/or for each measId corresponding to the SCG, if the associated reportConfig has a reportType set to condTriggerConfig, the following step(s) is(are) performed:
8.2.1. If the measId is indicated in condExecutionCond (associated with condReconfigId in VarConditionalReconfig) or condExecutionCondSCG, the report configuration associated with the measurement identity, the measurement object associated with the measurement identity, and the measurement identity stored in the UE are retained;
8.2.2. otherwise, the report configuration associated with the measurement identity, the measurement object associated with the measurement identity and the measurement identity stored in the UE are removed.

In step 9, deleting the report configuration associated with the measurement identity, the measurement object associated with the measurement identity, and the measurement identity stored in the UE in step 8 may be implemented through the following process:
For the measurement ID:
for the associated reportConfigId:
remove the entry with the matching reportConfigId from the reportConfigList within the VarMeasConfig;
if the associated measObjectId is only associated to a reportConfig with reportType set to condTriggerConfig;
remove the entry with the matching measObjectId from the measObjectList within the VarMeasConfig;
remove the entry with the matching measId from the measIdList within the VarMeasConfig.

The steps in the implementation(s) or embodiment(s) and optional examples thereof may be arbitrarily combined or the order of the steps may be arbitrarily changed, and the implementation(s) or embodiment(s) and optional examples thereof may be arbitrarily combined with other implementations or embodiments and optional examples thereof, if such combination or change will not result in contradictions.

The following describes embodiments of apparatuses of the present application, which can be used to perform the embodiments of the methods of the present application. For details not disclosed in the embodiments of the apparatuses of the present application, reference may be made to the embodiments of the methods of the present application.

Referring to FIG. 11, a block diagram of a first conditional reconfiguration apparatus provided by an embodiment of the present application is shown. The apparatus has function(s) of implementing the above-mentioned conditional reconfiguration method examples at the terminal device side. The function(s) may be implemented by hardware, or by hardware executing corresponding software. The apparatus may be the terminal device described above, or may be set in the terminal device. As shown in FIG. 11, the apparatus 1100 may include: a processing module 1110.

The processing module 1110 is configured to, after successfully accessing a target cell or a target cell group, perform a conditional reconfiguration procedure, wherein the conditional reconfiguration procedure refers to a procedure of processing a mobility action based on conditional triggering performed by the terminal device.

In some embodiments, the processing module 1110 is further configured to: after triggering the mobility action or successfully accessing the target cell or the target cell group, retain first information, wherein the first information is part or all of configuration information of a conditional reconfiguration stored in the terminal device.

In some embodiments, as shown in FIG. 12, the apparatus 1100 further includes a receiving module 1120.

The receiving module 1120 is configured to obtain first configuration information, wherein the first configuration information includes configuration information of a conditional reconfiguration, and the configuration information of the conditional reconfiguration is used in the conditional reconfiguration procedure;

The processing module is configured to perform the conditional reconfiguration procedure according to the first configuration information.

In some embodiments, the receiving module 1120 is configured to receive second configuration information, wherein the second configuration information includes the first configuration information, and the second configuration information includes information used to configure the target cell or the target cell group.

In some embodiments, the receiving module 1120 is configured to receive a Radio Resource Control (RRC) message, wherein the RRC message includes the second configuration information.

In some embodiments, the processing module 1110 is configured to, in a case where the second configuration information includes synchronization reconfiguration information, perform the conditional reconfiguration procedure according to the first configuration information, wherein the synchronization reconfiguration information is used to configure a synchronization procedure between the terminal device and the target cell or the target cell group.

In some embodiments, the first configuration information includes: configuration information used to configure or reconfigure a CPAC procedure;

wherein the target cell is a PCell corresponding to a CHO procedure, and the target cell group is an MCG corresponding to the CHO procedure.

In some embodiments, the first configuration information includes: configuration information used to configure or reconfigure a CHO procedure and/or a CPAC procedure;

wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding the second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein the conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of configuration information of a conditional reconfiguration stored in the terminal device.

In some embodiments, the first information includes at least one of:
configuration information of a conditional reconfiguration associated with the target cell or the target cell group;
configuration information of a conditional reconfiguration included in mobility configuration information for triggering the mobility action;
first configuration information, wherein the first configuration information including configuration information of a conditional reconfiguration, and the configuration information of the conditional reconfiguration is used in the conditional reconfiguration procedure;
configuration information of a conditional reconfiguration indicated by a network device.

In some embodiments, the first information is part of the configuration information of the conditional reconfiguration stored in the terminal device; the processing module is configured to: after triggering the mobility action or successfully accessing the target cell or the target cell group, remove second information, wherein the second information is information other than the first information in the configuration information of the conditional reconfiguration stored in the terminal device.

In some embodiments, the second information includes at least one of:
configuration information of a conditional reconfiguration not associated with the target cell or the target cell group;
mobility configuration information other than configuration information of a conditional reconfiguration included in a mobility configuration for triggering the mobility action;
mobility configuration information other than the first configuration information included in second configuration information, wherein the second configuration information is used to configure information of the target cell or the target cell group, the first configuration information includes the configuration information of the conditional reconfiguration, and the configuration information of the conditional reconfiguration is used in the conditional reconfiguration procedure;
configuration information of a conditional reconfiguration indicated by a network device.

In some embodiments, the second configuration information includes synchronization reconfiguration information;
wherein the configuration information of the conditional reconfiguration included in the mobility configuration information for triggering the mobility action is the configuration information of the conditional reconfiguration associated with the target cell or the target cell group, and the synchronization reconfiguration information is used to configure a synchronization procedure between the terminal device and the target cell or the target cell group.

In some embodiments, the receiving module 1120 is configured to receive indication information sent by the network device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which CPAC configuration information is applicable;
a PCell to which the CPAC configuration information is applicable;
an MN to which the CPAC configuration information is applicable.

In some embodiments, configuration information of a conditional reconfiguration entry corresponds to one piece of indication information;
wherein for configuration information of any conditional reconfiguration entry, the terminal device determines whether to retain or remove the configuration information of the conditional reconfiguration according to whether the network device sends indication information corresponding to the configuration information of the conditional reconfiguration; or
wherein for configuration information of any conditional reconfiguration entry, the terminal device determines whether to retain or remove the configuration information of the conditional reconfiguration according to a value of the indication information corresponding to the configuration information conditional reconfiguration.

In some embodiments, the processing module 1110 is further configured to retain measurement configuration information corresponding to the first information, wherein the measurement configuration information is used to configure an event related to a conditional reconfiguration procedure corresponding to the first information, and the conditional reconfiguration procedure refers to a procedure of reconfiguring or updating the mobility action based on conditional triggering performed by the terminal device.

In some embodiments, the processing module 1110 is further configured to remove measurement configuration information corresponding to the second information, wherein the measurement configuration information is used to configure an event related to a conditional reconfiguration procedure corresponding to the second information.

In some embodiments, the measurement configuration information includes at least one of: a measurement identity (ID) corresponding to the configuration information of the conditional reconfiguration, a measurement object associated with the measurement identity (ID), or a report configuration.

In some embodiments, the first information is used to configure or reconfigure a CPAC procedure;
wherein the target cell is a PCell corresponding to a CHO procedure, and the target cell group is an MCG corresponding to the CHO procedure.

In some embodiments, the first information is used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the mobility action includes at least one of:
the mobility action based on conditional triggering or a mobility action based on network signaling triggering;
wherein the mobility action based on conditional triggering includes at least one of: CHO, CPA, CPC, cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

In the technical solutions provided in the embodiments of the present application, by performing the conditional reconfiguration procedure after the terminal device successfully accesses the target cell or the target cell group, there is no need for the network device to reconfigure or reinitialize a configuration of the conditional reconfiguration for the terminal device, thereby saving signaling processes, reducing signaling transmission overhead, and reducing the duration of service interruption caused by a cell group change.

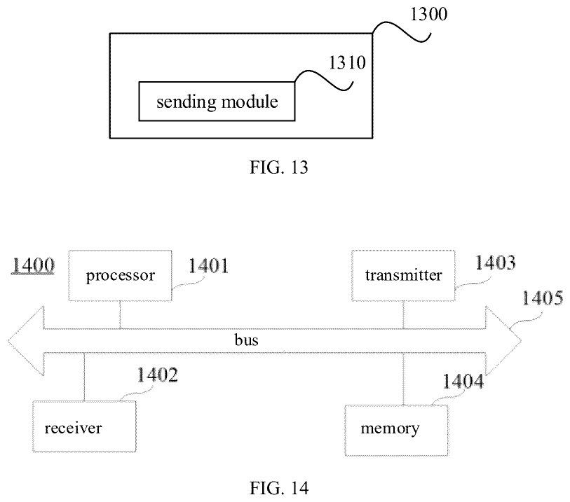

Referring to FIG. 13, a block diagram of a second conditional reconfiguration apparatus provided by another embodiment of the present application is shown. The apparatus has function(s) of implementing the above-mentioned conditional reconfiguration method examples at the network device side. The function(s) may be implemented by hardware, or by hardware executing corresponding software. The apparatus may be the network device described above, or may be set in the network device. As shown in FIG. 13, the apparatus 1300 may include: a sending module 1310.

The sending module 1310 is configured to send first configuration information to a terminal device, wherein the first configuration information includes configuration information of a conditional reconfiguration, and the configuration information of the conditional reconfiguration is used for a conditional reconfiguration procedure, and the conditional reconfiguration procedure is performed by the terminal device after the terminal device successfully accesses a target cell or a target cell group, and the conditional reconfiguration procedure refers to a procedure of processing a mobility action based on conditional triggering performed by the terminal device.

In some embodiments, the sending module 1310 is configured to send second configuration information to the terminal device, wherein the second configuration information includes the first configuration information, and the second configuration information includes information used to configure the target cell or the target cell group.

In some embodiments, the sending module 1310 is configured to send a Radio Resource Control (RRC) message to the terminal device, wherein the RRC message includes the second configuration information.

In some embodiments, the sending module 1310 is further configured to send indication information to the terminal device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which CPAC configuration information is applicable;
a PCell to which the CPAC configuration information is applicable;
an MN to which the CPAC configuration information is applicable.

In some embodiments, configuration information of a conditional reconfiguration entry corresponds to one piece of indication information;
wherein for any indication information, the network device determines whether to send the indication information according to whether the terminal device needs to retain or remove the configuration information of the conditional reconfiguration corresponding to the indication information; or
wherein for any indication information, the network device determines a value of the indication information according to whether the terminal device needs to retain or remove the configuration information of the conditional reconfiguration corresponding to the indication information.

In some embodiments, the second configuration information includes synchronization reconfiguration information, and the synchronization reconfiguration information is used to configure a synchronization procedure between the terminal device and the target cell or the target cell group.

In some embodiments, the first configuration information includes: configuration information used to configure or reconfigure a CPAC procedure;
wherein the target cell is a PCell corresponding to a CHO procedure, and the target cell group is an MCG corresponding to the CHO procedure.

In some embodiments, the first configuration information includes: configuration information used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of the configuration information of the conditional reconfiguration stored in the terminal device.

In some embodiments, the mobility action includes at least one of:
the mobility action based on conditional triggering or a mobility action based on network signaling triggering;
wherein the mobility action based on conditional triggering includes at least one of: CHO, CPA, CPC, cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

In the technical solutions provided in the embodiments of the present application, by performing the conditional reconfiguration procedure after the terminal device successfully accesses the target cell or the target cell group, there is no need for the network device to reconfigure or reinitialize a configuration of the conditional reconfiguration for the terminal device, thereby saving signaling processes, reducing signaling transmission overhead, and reducing the duration of service interruption caused by a cell group change.

It should be noted that regarding the apparatuses in the above embodiments, when the apparatuses implement their functions, the division of the above-mentioned functional modules is merely an example. In actual applications, the above-mentioned functions may be assigned to different functional modules according to actual needs, that is, the content structure of the apparatuses may be divided into different functional modules to complete all or part of the functions described above.

Regarding the apparatuses in the above embodiments, the specific manner in which each module performs operations has been described in detail in the embodiments of the methods, and repeated descriptions will be omitted here.

FIG. 14 is a block diagram of a communication device 1400 according to an example embodiment. The communication device 1400 may be the above described terminal device or network device. The communication device 1400 may include: a processor 1401, a receiver 1402, a transmitter 1403, a memory 1404, and a bus 1405. The processor 1401 may be configured to implement the functions of the processing module in the above described apparatus embodiments. The receiver 1402 may be configured to implement the functions of the receiving module in the above described apparatus embodiments. The transmitter 1403 may be configured to implement the functions of the sending module in the above described apparatus embodiments.

The processor 1401 includes one or more processing cores. The processor 1401 executes various functional applications and information processing by running software programs and modules.

The receiver 1402 and the transmitter 1403 may be implemented as a communication component, which may be a communication chip.

The memory 1404 is connected to the processor 1401 through the bus 1405.

The memory 1404 may be configured to store a computer program, and the processor 1401 may be configured to execute the computer program to implement the conditional reconfiguration methods at the terminal device side or the conditional reconfiguration methods at the network device side.

In addition, the memory 1404 may be implemented by any type of volatile or non-volatile storage device or a combination thereof. The volatile or non-volatile storage device includes but is not limited to: a magnetic disk or an optical disk, an Electrically Erasable Programmable Read-Only Memory (EEPROM), an Erasable Programmable Read-Only Memory (EPROM), a Static Random-Access Memory (SRAM), a Read-Only Memory (ROM), a magnetic memory, a flash memory, or a Programmable Read-Only Memory (PROM).

An embodiment of the present application further provides a computer-readable storage medium, in which a computer program is stored. The computer program is used to be executed by a processor to implement the above described conditional reconfiguration methods. Optionally, the computer-readable storage medium may include: Read-Only Memory (ROM), Random-Access Memory (RAM), Solid State Drives (SSD), or optical disk, etc. The random access memory may include Resistance Random Access Memory (ReRAM) and Dynamic Random Access Memory (DRAM).

An embodiment of the present application also provides a chip, which includes a programmable logic circuit and/or program instructions. When the chip is running, it is configured to implement the conditional reconfiguration methods at the terminal device side or the conditional reconfiguration methods at the network device side.

An embodiment of the present application further provides a computer program product, which includes a computer program, and the computer program is stored in a computer-readable storage medium. A processor reads and executes the computer program from the computer-readable storage medium to implement the above described conditional reconfiguration methods at the terminal device side, or to implement the above described conditional reconfiguration methods at the network device side.

An embodiment of the present application further provides a communication system, which includes a terminal device and a network device. The terminal device is configured to implement the conditional reconfiguration methods at the terminal device side, or to implement the conditional reconfiguration methods at the network device side.

Further example embodiments are provided as follows:

In some embodiments, the method further includes: after triggering the mobility action or successfully accessing the target cell or the target cell group, retaining first information, wherein the first information is part or all of configuration information of a conditional reconfiguration stored in the terminal device.

In some embodiments, performing the conditional reconfiguration procedure includes:
obtaining first configuration information, wherein the first configuration information includes configuration information of a conditional reconfiguration, and the configuration information of the conditional reconfiguration is used in the conditional reconfiguration procedure; and
performing the conditional reconfiguration procedure according to the first configuration information.

In some embodiments, obtaining the first configuration information includes:
receiving second configuration information, wherein the second configuration information includes the first configuration information, and the second configuration information includes information used to configure the target cell or the target cell group.

In some embodiments, receiving the second configuration information includes:
receiving a Radio Resource Control (RRC) message, wherein the RRC message includes the second configuration information.

In some embodiments, performing the conditional reconfiguration procedure according to the first configuration information includes:

in a case where the second configuration information includes synchronization reconfiguration information, performing the conditional reconfiguration procedure according to the first configuration information, wherein the synchronization reconfiguration information is used to configure a synchronization procedure between the terminal device and the target cell or the target cell group.

In some embodiments, the first configuration information includes: configuration information used to configure or reconfigure a CPAC procedure;
wherein the target cell is a Primary Cell (PCell) corresponding to a CHO procedure, and the target cell group is a Master Cell Group (MCG) corresponding to the CHO procedure.

In some embodiments, the first configuration information includes: configuration information used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding the second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein the conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of configuration information of a conditional reconfiguration stored in the terminal device.

In some embodiments, the first information includes at least one of:
configuration information of a conditional reconfiguration associated with the target cell or the target cell group;
configuration information of a conditional reconfiguration included in mobility configuration information triggering the mobility action;
first configuration information, wherein the first configuration information including configuration information of a conditional reconfiguration, and the configuration information of the conditional reconfiguration is used in the conditional reconfiguration procedure;
configuration information of a conditional reconfiguration indicated by a network device.

In some embodiments, the first information is part of the configuration information of the conditional reconfiguration stored in the terminal device; wherein the method further includes:
after triggering the mobility action or successfully accessing the target cell or the target cell group, removing second information, wherein the second information is information other than the first information in the configuration information of the conditional reconfiguration stored in the terminal device.

In some embodiments, the second information includes at least one of:
configuration information of a conditional reconfiguration not associated with the target cell or the target cell group;
mobility configuration information other than configuration information of a conditional reconfiguration included in a mobility configuration for triggering the mobility action;
mobility configuration information other than the first configuration information included in second configuration information, wherein the second configuration information is used to configure information of the target cell or the target cell group, the first configuration information includes the configuration information of the conditional reconfiguration, and the configuration information of the conditional reconfiguration is used in the conditional reconfiguration procedure;
configuration information of a conditional reconfiguration indicated by a network device.

In some embodiments, the second configuration information includes synchronization reconfiguration information;
wherein the configuration information of the conditional reconfiguration included in the mobility configuration information for triggering the mobility action is the configuration information of the conditional reconfiguration associated with the target cell or the target cell group, and the synchronization reconfiguration information is used to configure a synchronization procedure between the terminal device and the target cell or the target cell group.

In some embodiments, the method further includes:
receiving indication information sent by the network device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which CPAC configuration information is applicable;
a PCell to which the CPAC configuration information is applicable;
a Master Node (MN) to which the CPAC configuration information is applicable.

In some embodiments, configuration information of a conditional reconfiguration entry corresponds to one piece of indication information;
wherein for configuration information of any conditional reconfiguration entry, the terminal device determines whether to retain or remove the configuration information of the conditional reconfiguration according to whether the network device sends indication information corresponding to the configuration information of the conditional reconfiguration; or
wherein for configuration information of any conditional reconfiguration entry, the terminal device determines whether to retain or remove the configuration information of the conditional reconfiguration according to a value of the indication information corresponding to the configuration information conditional reconfiguration.

In some embodiments, the method further includes:
retaining measurement configuration information corresponding to the first information, wherein the measurement configuration information is used to configure an event related to a conditional reconfiguration procedure corresponding to the first information, and the conditional reconfiguration procedure refers to a procedure of reconfiguring or updating the mobility action based on conditional triggering performed by the terminal device.

In some embodiments, the method further includes:
deleting measurement configuration information corresponding to the second information, wherein the measurement configuration information is used to configure an event related to a conditional reconfiguration procedure corresponding to the second information.

In some embodiments, the measurement configuration information includes at least one of: a measurement identity (ID) corresponding to the configuration information of the conditional reconfiguration, a measurement object associated with the measurement identity (ID), or a report configuration.

In some embodiments, the first information is used to configure or reconfigure a CPAC procedure;
wherein the target cell is a PCell corresponding to a CHO procedure, and the target cell group is an MCG corresponding to the CHO procedure.

In some embodiments, the first information is used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the mobility action includes at least one of:
the mobility action based on conditional triggering or a mobility action based on network signaling triggering;
wherein the mobility action based on conditional triggering includes at least one of: CHO, Conditional Primary secondary cell Addition (Conditional PSCell Addition, CPA), Conditional Primary secondary cell Change (Conditional PSCell Change, CPC), cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

In some embodiments, sending the first configuration information includes:
sending second configuration information to the terminal device, wherein the second configuration information includes the first configuration information, and the second configuration information includes information used to configure the target cell or the target cell group.

In some embodiments, sending the second configuration information includes:
sending an RRC message to the terminal device, wherein the RRC message includes the second configuration information.

In some embodiments, the method further includes:
sending indication information to the terminal device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which Conditional CPAC configuration information is applicable;
a PCell to which the CPAC configuration information is applicable;
an MN to which the CPAC configuration information is applicable.

In some embodiments, configuration information of a conditional reconfiguration entry corresponds to one piece of indication information;
wherein for any indication information, the network device determines whether to send the indication information according to whether the terminal device needs to retain or remove the configuration information of the conditional reconfiguration corresponding to the indication information; or
wherein for any indication information, the network device determines a value of the indication information according to whether the terminal device needs to retain or remove the configuration information of the conditional reconfiguration corresponding to the indication information.

In some embodiments, the second configuration information includes synchronization reconfiguration information, and the synchronization reconfiguration information is used to configure a synchronization procedure between the terminal device and the target cell or the target cell group.

In some embodiments, the first configuration information includes: configuration information used to configure or reconfigure a CPAC procedure;
wherein the target cell is a PCell corresponding to a CHO procedure, and the target cell group is an MCG corresponding to the CHO procedure.

In some embodiments, the first configuration information includes: configuration information used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of the configuration information of the conditional reconfiguration stored in the terminal device.

In some embodiments, the mobility action includes at least one of:
the mobility action based on conditional triggering or a mobility action based on network signaling triggering;
wherein the mobility action based on conditional triggering includes at least one of: CHO, CPA, CPC, cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

According to an embodiment of the present application, there is provided a first conditional reconfiguration apparatus, including:
a processing module configured to perform a conditional reconfiguration procedure after successfully accessing a target cell or a target cell group, wherein the conditional reconfiguration procedure refers to a procedure of processing a mobility action based on conditional triggering performed by a terminal device.

In some embodiments, the processing module is further configured to: after triggering the mobility action or successfully accessing the target cell or the target cell group, retain first information, wherein the first information is part or all of configuration information of a conditional reconfiguration stored in the terminal device.

In some embodiments, the apparatus further includes:
a receiving module configured to obtain first configuration information, wherein the first configuration information includes configuration information of a conditional reconfiguration, and the configuration information of the conditional reconfiguration is used in the conditional reconfiguration procedure;
the processing module is configured to perform the conditional reconfiguration procedure according to the first configuration information.

In some embodiments, the receiving module is configured to: receive second configuration information, wherein the second configuration information includes the first configuration information, and the second configuration information includes information used to configure the target cell or the target cell group.

In some embodiments, the receiving module is configured to: receive an RRC message, wherein the RRC message includes the second configuration information.

In some embodiments, the processing module is configured to, in a case where the second configuration information includes synchronization reconfiguration information, perform the conditional reconfiguration procedure according to the first configuration information, wherein the synchronization reconfiguration information is used to configure a synchronization procedure between the terminal device and the target cell or the target cell group.

In some embodiments, the first configuration information includes: configuration information used to configure or reconfigure a CPAC procedure;
wherein the target cell is a PCell corresponding to a CHO procedure, and the target cell group is an MCG corresponding to the CHO procedure.

In some embodiments, the first configuration information includes: configuration information used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding the second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein the conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of configuration information of a conditional reconfiguration stored in the terminal device.

In some embodiments, the first information includes at least one of:
configuration information of a conditional reconfiguration associated with the target cell or the target cell group;
configuration information of a conditional reconfiguration included in mobility configuration information for triggering the mobility action;
first configuration information, wherein the first configuration information including configuration information of a conditional reconfiguration, and the configuration information of the conditional reconfiguration is used in the conditional reconfiguration procedure;
configuration information of a conditional reconfiguration indicated by a network device.

In some embodiments, the first information is part of the configuration information of the conditional reconfiguration stored in the terminal device; the processing module is further configured to: after triggering the mobility action or successfully accessing the target cell or the target cell group, remove second information, wherein the second information is information other than the first information in the configuration information of the conditional reconfiguration stored in the terminal device.

In some embodiments, the second information includes at least one of:
configuration information of a conditional reconfiguration not associated with the target cell or the target cell group;
mobility configuration information other than configuration information of a conditional reconfiguration included in a mobility configuration for triggering the mobility action;
mobility configuration information other than the first configuration information included in second configuration information, wherein the second configuration information is used to configure information of the target cell or the target cell group, the first configuration information includes the configuration information of the conditional reconfiguration, and the configuration information of the conditional reconfiguration is used in the conditional reconfiguration procedure;
configuration information of a conditional reconfiguration indicated by a network device.

In some embodiments, the second configuration information includes synchronization reconfiguration information;
wherein the configuration information of the conditional reconfiguration included in the mobility configuration information for triggering the mobility action is the configuration information of the conditional reconfiguration associated with the target cell or the target cell group, and the synchronization reconfiguration information is used to configure a synchronization procedure between the terminal device and the target cell or the target cell group.

In some embodiments, the receiving module is configured to receive indication information sent by the network device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which CPAC configuration information is applicable;
a PCell to which the CPAC configuration information is applicable;
an MN to which the CPAC configuration information is applicable.

In some embodiments, configuration information of a conditional reconfiguration entry corresponds to one piece of indication information;
wherein for configuration information of any conditional reconfiguration entry, the terminal device determines whether to retain or remove the configuration information of the conditional reconfiguration according to whether the network device sends indication information corresponding to the configuration information of the conditional reconfiguration; or
wherein for configuration information of any conditional reconfiguration entry, the terminal device determines whether to retain or remove the configuration information of the conditional reconfiguration according to a value of the indication information corresponding to the configuration information conditional reconfiguration.

In some embodiments, the processing module is further configured to retain measurement configuration information corresponding to the first information, wherein the measurement configuration information is used to configure an event related to a conditional reconfiguration procedure corresponding to the first information, and the conditional reconfiguration procedure refers to a procedure of reconfiguring or updating the mobility action based on conditional triggering performed by the terminal device.

In some embodiments, the processing module is further configured to remove measurement configuration information corresponding to the second information, wherein the measurement configuration information is used to configure an event related to a conditional reconfiguration procedure corresponding to the second information.

In some embodiments, the measurement configuration information includes at least one of: a measurement identity (ID) corresponding to the configuration information of the conditional reconfiguration, a measurement object associated with the measurement identity (ID), or a report configuration.

In some embodiments, the first information is used to configure or reconfigure a CPAC procedure;
wherein the target cell is a PCell corresponding to a CHO procedure, and the target cell group is an MCG corresponding to the CHO procedure.

In some embodiments, the first information is used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the mobility action includes at least one of:
the mobility action based on conditional triggering or a mobility action based on network signaling triggering;
wherein the mobility action based on conditional triggering includes at least one of: CHO, CPA, CPC, cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

According to an embodiment of the present application, there is provided a second conditional reconfiguration apparatus, including:
a sending module configured to send first configuration information to a terminal device, wherein the first configuration information includes configuration information of a conditional reconfiguration, and the configuration information of the conditional reconfiguration is used for a conditional reconfiguration procedure, and the conditional reconfiguration procedure is performed by the terminal device after the terminal device successfully accesses a target cell or a target cell group, and the conditional reconfiguration procedure refers to a procedure of processing a mobility action based on conditional triggering performed by the terminal device.

In some embodiments, the sending module is configured to send second configuration information to the terminal device, wherein the second configuration information includes the first configuration information, and the second configuration information includes information used to configure the target cell or the target cell group.

In some embodiments, the sending module is configured to send a Radio Resource Control (RRC) message to the terminal device, wherein the RRC message includes the second configuration information.

In some embodiments, the sending module is further configured to send indication information to the terminal device, wherein the indication information is used to indicate configuration information of a conditional reconfiguration that the terminal device needs to retain or remove, and the indication information includes at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
an MCG to which CPAC configuration information is applicable;
a PCell to which the CPAC configuration information is applicable;
an MN to which the CPAC configuration information is applicable.

In some embodiments, configuration information of a conditional reconfiguration entry corresponds to one piece of indication information;
wherein for any indication information, the network device determines whether to send the indication information according to whether the terminal device needs to retain or remove the configuration information of the conditional reconfiguration corresponding to the indication information; or
wherein for any indication information, the network device determines a value of the indication information according to whether the terminal device needs to retain or remove the configuration information of the conditional reconfiguration corresponding to the indication information.

In some embodiments, the second configuration information includes synchronization reconfiguration information, and the synchronization reconfiguration information is used to configure a synchronization procedure between the terminal device and the target cell or the target cell group.

In some embodiments, the first configuration information includes: configuration information used to configure or reconfigure a CPAC procedure;
wherein the target cell is a PCell corresponding to a CHO procedure, and the target cell group is an MCG corresponding to the CHO procedure.

In some embodiments, the first configuration information includes: configuration information used to configure or reconfigure a CHO procedure and/or a CPAC procedure;
wherein the target cell is a cell included in a handover command, the target cell group is a cell group included in the handover command, and the handover command is used to indicate the terminal device to switch to the target cell and/or the target cell group.

In some embodiments, the conditional reconfiguration procedure includes at least one of: conditional reconfiguration addition, conditional reconfiguration modification, conditional reconfiguration removal, conditional reconfiguration evaluation and conditional reconfiguration execution;
wherein the conditional reconfiguration addition refers to adding second configuration information to the configuration information of the conditional reconfiguration stored in the terminal device;
wherein the conditional reconfiguration modification refers to modifying the configuration information of the conditional reconfiguration stored in the terminal device according to the second configuration information;
wherein conditional reconfiguration removal refers to removing the second configuration information in the configuration information of the conditional reconfiguration stored in the terminal device;
wherein the conditional reconfiguration evaluation refers to evaluating an execution condition for the mobility action based on conditional triggering corresponding to the configuration information of the conditional reconfiguration stored in the terminal device;
wherein the conditional reconfiguration execution refers to executing the mobility action based on conditional triggering corresponding to the configuration information of the conditional reconfiguration stored in the terminal device.

In some embodiments, the conditional reconfiguration procedure is performed after deleting part or all of the configuration information of the conditional reconfiguration stored in the terminal device.

In some embodiments, the mobility action includes at least one of:
the mobility action based on conditional triggering or a mobility action based on network signaling triggering;
wherein the mobility action based on conditional triggering includes at least one of: CHO, CPA, CPC, cell or cell group activation based on conditional triggering, or cell or cell group deactivation based on conditional triggering;
wherein the mobility action based on network signaling triggering includes at least one of: cell or cell group activation based on network signaling triggering, or cell or cell group deactivation based on network signaling triggering.

The technical solutions provided by the embodiments of the present application may have the following beneficial effects:

By performing the conditional reconfiguration procedure after the terminal device successfully accesses the target cell or the target cell group, there is no need for the network device to reconfigure or reinitialize a configuration of the conditional reconfiguration for the terminal device, thereby saving signaling processes, reducing signaling transmission overhead, and reducing the duration of service interruption caused by a cell group change.

It should be understood that the “indication” mentioned herein may be a direct indication, an indirect indication, or may indicate that there is an association relationship. For example, A indicates B, which can mean: A directly indicates B, for example, B may be obtained through A; it can also mean: A indirectly indicates B, for example, A indicates C, B may be obtained through C; it can also mean: there is an association relationship between A and B.

The term “correspondence” mentioned herein may indicate a direct or indirect correspondence between two objects, or an association between the two objects, or a relationship of indicating and being indicated, configuring and being configured, etc.

The above described implementations or embodiments are not exhaustive, but are only illustrative of a part of implementations or embodiments, and are not intended to be specific limitations on the scope of protection of the embodiments of the present disclosure. Each step in a certain implementation or embodiment may be implemented as an independent embodiment, and steps may be combined arbitrarily, if such combination will not result in contradictions. For example, a solution obtained after removing a part of the steps in a certain implementation or embodiment may also be implemented as an independent embodiment, and the order of steps in a certain implementation or embodiment may be arbitrarily changed. In addition, optional methods or optional examples in a certain implementation or embodiment may be combined arbitrarily. In addition, various implementations or embodiments may be combined arbitrarily. For example, part or all steps of different implementations or embodiments may be combined arbitrarily, and a certain implementation or embodiment may be combined arbitrarily with optional methods or optional examples of other implementations or embodiments.

In addition, the expressions such as “A or B”, “A and/or B”, “at least one of A and B”, “A in a case, B in another case”, “in response to a case A, in response to another case B” mentioned herein may include at least one of the following schemes depending on situations: executing A independently of B, that is, A in some implementations; executing B independently of A, that is, B in some implementations; selectively executing A and B, that is, selecting from A and B to execute in some implementations; executing both A and B, that is, A and B in some implementations. In addition, each element, each row, or each column in table(s) involved in the embodiments of the present application may be implemented as an independent embodiment, and the combination of any element, any row, or any column may also be implemented as an independent embodiment.

The term “multiple” as used herein refers to two or more than two. The expression “and/or” describes an association relationship between associated objects, indicating that three relationships may exist. For example, A and/or B can mean: A exists alone, A and B exist at the same time, and B exists alone. The character “/” generally indicates that the related objects before and after the character are in an “or” relationship.

The “predefined” mentioned herein may be implemented by pre-storing corresponding codes, tables or other methods that can be used to indicate relevant information in a device (for example, including a terminal device and a network device), and the present application does not limit the specific implementation. For example, predefined may refer to being defined in a specification.

The “specification” mentioned herein may refer to a standard specification in the communication field, for example, it may include an LTE specification, a NR specification, and related specifications used in future communication systems, which is not limited in the present application.

The term “greater than or equal to” mentioned herein may mean greater than or equal to, or greater than, and the term “less than or equal to” may mean less than or equal to, or less than.

In addition, the step numbers described herein only illustrate a possible execution order between the steps. In some other embodiments, the above steps may not be executed in the order of the numbers. For example, two steps with different numbers are executed at the same time, or two steps with different numbers are executed in the opposite order to that shown in the figures. The embodiments of the present application do not impose limitations on this.

Those skilled in the art should be aware that in one or more of the above examples, the functions described in the embodiments of the present application may be implemented with hardware, software, firmware, or any combination thereof. When implemented using software, these functions may be stored in a computer-readable medium or transmitted as one or more instructions or codes on a computer-readable medium. The computer-readable medium includes a computer storage medium and a communication medium. The communication medium includes any medium that facilitates the transmission of a computer program from one place to another. The storage medium may be any available medium that a general or special-purpose computer can access.

The above description shows only example embodiments of the present application and is not intended to limit the present application. Any modifications, equivalent substitutions, improvements, etc. made within the spirit and principles of the present application should fall within the protection scope of the present application.

1. A conditional reconfiguration method, wherein the method is performed by a terminal device, and the method comprises:
after successfully accessing a target cell or a target cell group, performing a conditional reconfiguration procedure, wherein the conditional reconfiguration procedure refers to a procedure of processing a mobility action based on conditional triggering performed by the terminal device.

2. The method according to claim 1, further comprising:
after triggering the mobility action or successfully accessing the target cell or the target cell group, retaining first information, wherein the first information is part or all of configuration information of a conditional reconfiguration stored in the terminal device.

3. The method according to claim 1, wherein performing the conditional reconfiguration procedure comprises:
obtaining first configuration information, wherein the first configuration information comprises configuration information of a conditional reconfiguration, and the configuration information of the conditional reconfiguration is used in the conditional reconfiguration procedure; and
performing the conditional reconfiguration procedure according to the first configuration information.

4. The method according to claim 3, wherein obtaining the first configuration information comprises:
receiving second configuration information, wherein the second configuration information comprises the first configuration information, and the second configuration information comprises information used to configure the target cell or the target cell group.

5. The method according to claim 4, wherein receiving the second configuration information comprises:
receiving a Radio Resource Control (RRC) message, wherein the RRC message comprises the second configuration information.

6. The method according to claim 4, wherein performing the conditional reconfiguration procedure according to the first configuration information comprises:
in a case where the second configuration information comprises synchronization reconfiguration information, performing the conditional reconfiguration procedure according to the first configuration information, wherein the synchronization reconfiguration information is used to configure a synchronization procedure between the terminal device and the target cell or the target cell group.

7. The method according to claim 3, wherein the first configuration information comprises: configuration information used to configure or reconfigure a Conditional Primary secondary cell Addition or Change (CPAC) procedure;
wherein the target cell is a Primary Cell (PCell) corresponding to a Conditional Handover (CHO) procedure, and the target cell group is a Master Cell Group (MCG) corresponding to the CHO procedure; or
wherein the first configuration information comprises: configuration information used to configure or reconfigure a CHO procedure or a CPAC procedure, or the first configuration information comprises configuration information used to configure or reconfigure the CHO procedure and the CPAC procedure;
wherein the target cell is a cell comprised in a handover command, the target cell group is a cell group comprised in the handover command, and the handover command is used to indicate the terminal device to switch to at least one of the target cell or the target cell group.

8.-11. (canceled)

12. The method according to claim 2, wherein the first information is part of the configuration information of the conditional reconfiguration stored in the terminal device;
wherein the method further comprises:
after triggering the mobility action or successfully accessing the target cell or the target cell group, removing second information, wherein the second information is information other than the first information in the configuration information of the conditional reconfiguration stored in the terminal device.

13. The method according to claim 12, wherein the second information comprises at least one of:
configuration information of a conditional reconfiguration not associated with the target cell or the target cell group;
mobility configuration information other than configuration information of a conditional reconfiguration comprised in a mobility configuration for triggering the mobility action;
mobility configuration information other than the first configuration information comprised in second configuration information, wherein the second configuration information is used to configure information of the target cell or the target cell group, the first configuration information comprises the configuration information of the conditional reconfiguration, and the configuration information of the conditional reconfiguration is used in the conditional reconfiguration procedure; or
configuration information of a conditional reconfiguration indicated by a network device.

14. The method according to claim 11, wherein the second configuration information comprises synchronization reconfiguration information;
wherein the configuration information of the conditional reconfiguration comprised in the mobility configuration information for triggering the mobility action is the configuration information of the conditional reconfiguration associated with the target cell or the target cell group, and the synchronization reconfiguration information is used to configure a synchronization procedure between the terminal device and the target cell or the target cell group.

15. The method according to claim 11, further comprising:
receiving indication information sent by the network device, wherein the indication information is used to indicate configuration information of a conditional reconfiguration that the terminal device needs to retain or remove, and the indication information comprises at least one of:
a configuration identity (ID) corresponding to the configuration information of the conditional reconfiguration;
a node corresponding to the configuration information of the conditional reconfiguration;
a cell or a cell group associated with the configuration information of the conditional reconfiguration;
a validity length of time for the configuration information of the conditional reconfiguration;
a Master Cell Group (MCG) to which Conditional Primary secondary cell Addition or Change (CPAC) configuration information is applicable;
a Primary Cell (PCell) to which the CPAC configuration information is applicable; or
a Master Node (MN) to which the CPAC configuration information is applicable.

16. The method according to claim 11, wherein configuration information of a conditional reconfiguration entry corresponds to one piece of indication information;
wherein for configuration information of any conditional reconfiguration entry, the terminal device determines whether to retain or remove the configuration information of the conditional reconfiguration according to whether the network device sends indication information corresponding to the configuration information of the conditional reconfiguration; or
wherein for configuration information of any conditional reconfiguration entry, the terminal device determines whether to retain or remove the configuration information of the conditional reconfiguration according to a value of the indication information corresponding to the configuration information conditional reconfiguration.

17. The method according to claim 2, further comprising:
retaining measurement configuration information corresponding to the first information, wherein the measurement configuration information is used to configure an event related to a conditional reconfiguration procedure corresponding to the first information, and the conditional reconfiguration procedure refers to a procedure of reconfiguring or updating the mobility action based on conditional triggering performed by the terminal device.

18. The method according to claim 12, further comprising:
deleting measurement configuration information corresponding to the second information, wherein the measurement configuration information is used to configure an event related to a conditional reconfiguration procedure corresponding to the second information.

19.-22. (canceled)

23. A conditional reconfiguration method, wherein the method is performed by a network device, and the method comprises:
sending first configuration information to a terminal device, wherein the first configuration information comprises configuration information of a conditional reconfiguration, and the configuration information of the conditional reconfiguration is used for a conditional reconfiguration procedure, and the conditional reconfiguration procedure is performed by the terminal device after the terminal device successfully accesses a target cell or a target cell group, and the conditional reconfiguration procedure refers to a procedure of processing a mobility action based on conditional triggering performed by the terminal device.

24. The method according to claim 23, wherein sending the first configuration information comprises:
sending second configuration information to the terminal device, wherein the second configuration information comprises the first configuration information, and the second configuration information comprises information used to configure the target cell or the target cell group.

25. The method according to claim 24, wherein sending the second configuration information comprises:
sending a Radio Resource Control (RRC) message to the terminal device, wherein the RRC message comprises the second configuration information.

26.-35. (canceled)

36. A terminal device, wherein the communication device comprises a processor and a memory, the memory stores a computer program, and when the processor executes the computer program, the terminal device is caused to:
after successfully access a target cell or a target cell group, perform a conditional reconfiguration procedure, wherein the conditional reconfiguration procedure refers to a procedure of processing a mobility action based on conditional triggering performed by the terminal device.

37. A non-transitory computer-readable storage medium, wherein a computer program is stored in the storage medium, and when the computer program is executed by a processor, the method according to claim 1 is implemented.

38.-40. (canceled)

41. A network device, wherein the communication device comprises a processor and a memory, the memory stores a computer program, and when the processor executes the computer program, the network device is caused to perform the method according to claim 23.
